(19) United States
(12) Patent Application Publication
(10) Pub. No.: US 2025/0016561 A1
(43) Pub. Date: Jan. 9, 2025

(54) FIRST DEVICE, FIRST NODE, NODE, AND METHODS PERFORMED THEREBY FOR HANDLING IDENTIFICATION OF THE DEVICE

(71) Applicant: Telefonaktiebolaget LM Ericsson (publ), Stockholm (SE)

(72) Inventor: Antonino ORSINO, KIRKKONUMMI (FI)

(73) Assignee: Telefonaktiebolaget LM Ericsson (publ), Stockholm (SE)

(21) Appl. No.: 18/699,801

(22) PCT Filed: Oct. 5, 2022
(86) PCT No.: PCT/SE2022/050888

§ 371 Date: Apr. 9, 2024

Related U.S. Application Data
(60) Provisional application No. 63/262,502, filed on Oct. 14, 2021.

(51) Int. Cl. H04W 12/06; H04W 8/22; H04W 92/18

(52) U.S. Cl. CPC H04W 12/06; H04W 8/22; H04W 92/18

(57) ABSTRACT

A performed by a first device (130). The method is for enabling identification of the first device (130). The first device (130) operates in a wireless communications network (100). The first device (130) determines (504) a first indication. The first indication is different than a second indication enabling identification of the first device (130) on its own. The first indication lacks a capability to enable identification of the first device (130) on its own. The determining (504) is based on the second indication and additional information. The first device (130) then provides (507) the determined first indication to a first node (111). The first node (111) operates in the wireless communications network (100). The providing (507) is over a sidelink. The providing (507) of the first indication thereby initiates enabling identification of the first device (130) by the first node (111) based on the additional information known to the first node (111).

### TECHNICAL FIELD

The present disclosure relates generally to a first device, and methods performed thereby, for enabling identification of the first device. The present disclosure also relates generally to a first node and methods performed thereby for enabling identification of the first device. The present disclosure further relates generally to a node and methods performed thereby for enabling identification of the first device.

### BACKGROUND

Wireless devices within a wireless communications network may be e.g., User Equipments (UE), wireless devices, stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone and/or between a wireless device and a server via a Radio Access Network (RAN) and possibly one or more core networks, comprised within the wireless communications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The wireless communications network covers a geographical area which may be divided into cell areas, each cell area being served by a network node, which may be an access node such as a radio network node, radio node or a base station, e.g., a Radio Base Station (RBS), which sometimes may be referred to as e.g., gNB, evolved Node B (“eNB”), “eNodeB”, “NodeB”, “B node”, Transmission Point (TP), or Base Transceiver Station (BTS), depending on the technology and terminology used. The base stations may be of different classes such as e.g., Wide Area Base Stations, Medium Range Base Stations, Local Area Base Stations, Home Base Stations, pico base stations, etc . . . , based on transmission power and thereby also cell size. A cell is the geographical area where radio coverage is provided by the base station or radio node at a base station site, or radio node site, respectively. One base station, situated on the base station site, may serve one or several cells. Further, each base station may support one or several communication technologies. The base stations communicate over the air interface operating on radio frequencies with the terminals within range of the base stations. The wireless communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. In the context of this disclosure, the expression Downlink (DL) may be used for the transmission path from the base station to the wireless device. The expression Uplink (UL) may be used for the transmission path in the opposite direction i.e., from the wireless device to the base station.

The standardization organization 3GPP is currently in the process of specifying a New Radio Interface called NR or 5G-UTRA, as well as a Fifth Generation (5G) Packet Core Network, which may be referred to as Next Generation (NG) Core Network (CN), abbreviated as NG-CN, NGC or 5G CN.

### Unmanned Aerial Vehicle (UAV) Communications in 3GPP

The world is witnessing a widespread and increasing use of drones, or more technically the Unmanned Aerial Vehicles (UAVs), in many segments of the economy and in our daily life. There are numerous use cases of UAVs in industry, goods transportation and delivery, surveillance, media production, etc.

Traditionally, the UAVs may only be flown by a controller within the visual line of sight (VLOS). Realizing the great potential of connecting drones beyond visual line of sight (BVLoS) via a cellular network, 3GPP have specified multiple features in LTE Rel-15, aiming at improving the efficiency and robustness of the terrestrial LTE network for providing aerial connectivity services, particularly for low altitude UAVs. These features target both command-and-control traffic for flying the drone and the data, also known as payload, traffic from the drone to the cellular network. The key features specified include, first, support for subscription-based identification, second, height reporting when an Unmanned Aerial Vehicle (UAV) crosses a height threshold. The report may include height, location, e.g., in three dimensions (3D), horizontal and vertical speed. Third, reference signal received power (RSRP) reporting per event of N cells' signal power above a threshold. The report may include RSRP/Reference signal received quality (RSRQ)/location (3D). Fourth, UE-specific UL power control. Fifth, flight path information provided from UE to eNB. This may include network polling and list of waypoints, 3D location, and time stamp, if available.

These features were introduced targeting special needs when serving the UAVs by an LTE network, e.g., the need for flying mode detection, interference detection, and interference mitigation. The first important issue was the flying mode detection, which may be understood to also be related to interference detection, as the interference conditions for flying aerial UEs may be different from aerial UE in terrestrial mode. For interference detection, which may also serve as input to flying mode detection, an enhancement to existing events triggering of RSRP/RSRQ/Reference signal Signal-to-Interference-plus-Noise Ratio (SINR) (RS-SINR) reports was introduced in LTE Rel-15. The UE may be configured to trigger an event such as A3, A4, A5, which all consider neighbor cell measurements. In such event triggers, a measurement report may be triggered when measured RSRPs, RSRQs and/or RS-SINRs of multiple cells may be above a threshold.

Another input to flying mode detection may be event triggered height and location reporting. A new configurable event within Radio Resource Management (RRM) with height threshold is introduced for Rel-15 Aerial UEs. When the UE is configured with an event, a report may be triggered when the altitude of the UE crosses the threshold altitude. In addition to flying mode detection, the exact height information may be considered useful as the network may choose to reconfigure for example measurement reporting configurations for the UE when it crosses a height threshold. FIG. 1 depicts this situation. FIG. 1 is a schematic diagram illustrating how Evolved Universal Terrestrial Radio Access Network (E-UTRAN) 10 may reconfigure an Aerial UE 11 based on flying altitude. In this figure, when the UE 11 is below a height of 100 m, the aerial UE 11 may be Radio Resource Control (RRC) configured 12 with measurement reporting configurations and event triggered height/location reporting corresponding to a height threshold of 200 m. As the aerial UE 11 crosses a height threshold of 200 m, a report 13 may be triggered from the UE 11 to the network 10. After receiving the report from the aerial UE 11, the network 10 may RRC reconfigure 14 the aerial UE 11 with new measurement reporting configurations.

### Sidelink Communications

3GPP specified the LTE device-to-device (D2D) technology, also known as the sidelink (SL) or the PC5 interface, as part of Release 12 (Rel-12). The target use case (UC) were the Proximity Services (ProSe), covering both communication and discovery. ProSe may be understood as services and applications that may exploit the connection between nearby devices. The design was enhanced during Rel-13. In Rel-14, the LTE SL was extensively redesigned to support vehicular communications, commonly referred to as Vehicle-to-anything communication (V2X), for road-safety applications and some further enhancements were specified during Rel-15. From the point of view of the lowest radio layer, the Physical (PHY) layer, the LTE SL may use broadcast communication, that is, the transmission from a transmitter UE may target all receiver UEs in its proximity.

In Rel-16, 3GPP introduced the sidelink for the 5G new radio (NR). The driving Use cases (UCs) were advanced V2X UCs, e.g., cooperative driving or sensor sharing, with more stringent requirements than those typically served using the LTE SL. To meet these requirements, the NR SL was designed to support both broadcast, groupcast, and unicast communications at the PHY layer. Notably, Hybrid Automatic Repeat Request (HARQ) feedback was introduced for SL groupcast and unicast.

Both LTE SL and NR SL may operate with and without network coverage and with varying degrees of interaction between the UEs and the network (NW), including support for network-less operation.

In the ongoing Rel-17, 3GPP is working on enhancements to the NR SL. The ambition is not only to improve the capabilities of NR SL for V2X but also to address other UCs, such as National Security and Public Safety (NSPS), as well as commercial UCs such as Network Controlled Interactive Services (NCIS). In particular, inter-UE coordination in resource allocation is being specified to improve the reliability of SL communications, whereas SL discontinuous reception (SL-DRX) and partial resource sensing are being specified for power/energy saving purposes.

There are two resource allocation modes in SL. In the first mode, SL transmissions by the UEs may be scheduled by a network node, e.g., eNB or gNB, that is, the network node may grant the SL resources to the UEs. This network-scheduled mode may be often referred to as Mode 1 in NR SL Rel-16 and as Mode 3 in LTE SL Rel-14. In the second mode, UEs may autonomously find resources for their SL transmissions in a set of resources configured by the network or preconfigured, often referred to as SL resource pool. This mode of resource allocation may be referred to as Mode 2 in NR SL Rel-16 and as Mode 4 in LTE SL Rel-14. In the latter mode, each UE may typically try to decode control information sent by the other UEs and measure interference level on different resource units to find the most suitable resources for the transmissions of the UE, a process often referred to as resource sensing.

### Sidelink Communications for UAV

There is a growing interest in the telecom industry to enhance the 5G NR standards to support UAV communication. This may include serving the UAVs as aerial-UEs via uplink and downlink, e.g., the Uu interface, and supporting direct communication between UAVs, e.g., via the PC5 interface. The latter may be considered useful for the collision Detection and Avoidance (D/A) use cases, wherein the UAVs may be able to detect the presence of one another and to react to avoid collisions. In fact, 3GPP has taken these demands into account when setting the requirements for Remote Identification of Unmanned aerial system/Unmanned aircraft system (UAS) in 3GPP TS 22.125 V17.3.0, March 2021, as may be seen in Section 5.22 “Decentralized UAS traffic management”, which is reproduced next, wherein each of the 11 requirements is indicated in a separate paragraph.

### Decentralized UAS Traffic Management

The 3GPP system may be required to enable a UAV to broadcast the following data for identifying UAV(s) in a short-range area for collision avoidance: e.g. UAV identities if needed based on different regulation requirements, UAV type, current location and time, flight route information, current speed, operating status.

The 3GPP system may be required to be able to support a UAV to transmit a message via network connection for identifying itself as an UAV to the other UAV(s).

The 3GPP system may be required to enable UAV to preserve the privacy of the owner of the UAV, UAV pilot, and the UAV operator in its broadcast of identity information.

The 3GPP system may be required to enable a UAV to receive local broadcast communication transport service from other UAV in short range.

A UAV may be required to be able to use a direct UAV to UAV local broadcast communication transport service in the coverage or out of coverage of a 3GPP network.

A UAV may be required to be able to use a direct UAV to UAV local broadcast communication transport service when the sending and receiving UAVs are served by the same or different Public Land Mobile Networks (PLMNs).

The 3GPP system may be required to support a direct UAV to UAV local broadcast communication transport service at relative speeds of up to 320 kmph.

The 3GPP system may be required to support a direct UAV to UAV local broadcast communication transport service with variable message payloads of 50-1500 bytes, not including security-related message component(s).

The 3GPP system may be required to support a direct UAV to UAV local broadcast communication transport service which supports a range of up to 600 m.

The 3GPP system may be required to support a direct UAV to UAV local broadcast communication transport service which may transmit messages at a frequency of at least 10 messages per second.

The 3GPP system may be required to support a direct UAV to UAV local broadcast communication transport service which may transmit messages with an end-to-end latency of at most 100 ms.

In summary, it may be required that the 3GPP system support the broadcasting of UAV identity and other information related to speed and route of the UAV over the PC5 interface for the purpose of collision detection and avoidance. Moreover, the UAV-to-UAV communication over PC5 may be required to be able to support regularly broadcasted messages with certain payload size and latency requirements, both in network coverage and out of network coverage.

### Unmanned Aircraft Systems (UAS) Traffic Management (UTM)

It may be understood to be utmost important to keep the airspace safe and accessible. Therefore, a system called UTM is being developed in different parts of the world to manage the traffic of the UAS. A UAS may be composed of a UAV and a UAV controller used by an operator with unique credentials and identities. According to NASA, UTM may be understood as a collaborative, automated, and federated airspace management approach that may enable safe, efficient, and equitable small UAS operations at scale. The concept of UTM is being adopted and implemented by many countries and regions in the world, e.g., in the US, Europe, Japan, Australia, etc.

According to reference [1], the UTM may provide many flight-related functions for UAVs and UAV operators, for example: a) remote identification, which may be understood to enable UAV identification, b) operation planning, which may be understood to comprise flight planning considering various aspects e.g., UAV performance, weather condition, c) operator messaging, which may be understood to comprise message exchange between operators for e.g., position and status information, d) Federal Aviation Agency (FAA) messaging, which may be understood to comprise providing on-demand, periodic, or event-triggered communications with FAA systems to meet regulatory requirements, e) mapping, which may be understood to comprise information about airspace restrictions, obstacles, and sensitive regions, and f) conflict advisory, which may be understood to comprise real-time alerting for collision avoidance.

FIG. 2 is a schematic diagram illustrating an example of UAS 20 to UTM 21 connectivity [1]. Mobile networks may enable reliable connectivity between the UAV 22 and its controller 23. Meanwhile, UTM 21 may connect to the UAV 22 and the UAV 23 controller through the core network 24 and the radio access network 25.

### Regulatory Aspects

Drone UE identification may be understood to be important in order to provide the right service optimization for drone UEs, to protect ground devices and for safety, security, regulatory, and law enforcement. In some regions, e.g., Japan, permission may be needed in order to be connected to an LTE network while airborne.

The drone identification is also heavily discussed in the USA. Law Enforcement, the Department of Homeland Security and the Department of Justice, blocked progress on relaxing Unmanned Aerial Vehicle (UAV), rules until the Federal Aviation Administration (FAA), came up with a solution for how to identify drones. In addition, states and local governments have passed drone related ordinances covering issues such as invasion of privacy, nuisance behavior, damage of property, etc. Two identification methods may be expected based on the class of drone. The first method may be Broadcast Identifier (ID). According to this method, the drone may transmit its identification and owner information. The second method may be Network Tracking. According to this method, the location information may be transmitted back to an Unmanned aerial system/Unmanned aircraft system (UAS), service supplier. Information on the drone may be obtained by querying the service supplier. Based on the class and usage of the drone one or both methods may be required. Currently, it is not expected that hobbyist drones will require remote Identifier (ID) functionality. Technologies used on larger aircraft are in general inadequate or too expensive for the small UAV market. The FAA has not yet selected a technical solution. The FAA has issued a Request for Information (RFI) collecting further information.

The Federal Communications Commission (FCC) Technical Advisory Committee is reviewing technologies but has only completed the evaluation for one technology. 3GPP technologies were found suitable for use in low altitude drones.

FIG. 3 is a schematic diagram depicting a non-limiting example of Four Tiered ID Spaces. According to this system, a UAV 30 may or may not need to provide its ID, based on the space where it may be located, out of four different defined spaces. In a first tier space 0, which may define a semi-spherical volume with a radius of 400 feet (ft), there may understood to be no ID requirements for a UAV 30. In a second tier space 1, which may define a semi-rectangular volume within the VLOS, with a height of 400 feet (ft) around and excluding the first tier space 0, there may understood to be a requirement for a UAV 30 to notify pre-flight, which notification of pre-flight may be broadcast, or network publish to the FAA 32. In a third tier space 2, which may define a space over 400 feet (ft) above ground level (AGL), BVLOS, here may understood to be a requirements for a UAV 30 to broadcast and network publish whether the UAV 30 may fly above 400 ft. In a fourth tier space 3, there may understood to be a requirements for a UAV 30 to comply with part 91 requirements of Automatic Dependent Surveillance-Broadcast (ADS-B). A space around airports 33 may be understood to be always controlled.

During the Rel-18 discussions that took place in the RAN plenary, the UAV communication topic was discussed and the following preliminary outcome was agreed as the Proposal from RAN #93e.

The following areas/objectives may be considered as a starting point for further discussions on UAV. A first area were measurement reports, pertaining to RAN2, particularly, a) UE-triggered measurement report based on configured height thresholds, b) reporting of height, location and speed in measurement report, c) flight path reporting, and d) measurement reporting based on a configured number of cells, i.e., larger than one, fulfilling the triggering criteria simultaneously. A second area was signaling to support subscription-based aerial-UE identification, pertaining to a RAN2/RAN3/SA2 interaction. The work done in LTE was understood to be a starting point for the above objectives intended to cover LTE UAV functionality including any NR-specific enhancements as necessary. A third area was support for broadcast/groupcast of drone identification over PC5 dependent on SA2 outcome, pertaining to RAN2, and applicable to both LTE and NR. A fourth area was to study and specify if needed: a) additional Radio Resource Management (RRM) enhancements to control volume of reports, pertaining to RAN2, b) mobility enhancements, e.g., for Conditional Handover (CHO), and c) beam management enhancements.

In spite of the current efforts to develop UAV communication, a problem with the existing technology is that drone UE identification according to existing methods may be subject to security attacks.

### SUMMARY

As part of the development of embodiments herein, one or more challenges with the existing technology will first be identified and discussed.

While the regular broadcasting and groupcast sidelink transmission may be used by the drones to broadcast their ID when public authorities may require so, there is an important factor that may need to be considered when reusing current sidelink transmissions type. In fact, even if the drone identification happens over PC5 by using PC5 broadcast or PC5 groupcast connection, the end-user of this may be understood to be a public authority, and not all the users in proximity, in case of broadcast transmissions, or within the same group, in case of groupcast transmissions. In fact, since other users may acquire the drone IDs when these may be broadcasted, privacy mechanisms may need to be in place in order to allow only the public authority to receive the ID, and not all the other users in proximity.

According to the foregoing, it is an object of embodiments herein to improve the handling of identification of a device in a wireless communications network.

According to a first aspect of embodiments herein, the object is achieved by a method, performed by a first device. The method is for enabling identification of the first device. The first device operates in the wireless communications network. The first device determines a first indication. The first indication is different than a second indication. The second indication enables identification of the first device on its own. The first indication lacks a capability to enable identification of the first device on its own. The determining is based on the second indication and the additional information. The first device then provides the determined first indication to a first node operating in the wireless communications network. The providing is over a sidelink. The providing may thereby initiate enabling identification of the first device by the first node. The identification may be based on the additional information. The additional information may be known to the first node.

According to a second aspect of embodiments herein, the object is achieved by a method, performed by a first node. The method is for enabling the identification of the first device. The first node and the first device operate in the wireless communications network. The first node receives, over a sidelink, the first indication from the first device. The first indication is different than the second indication. The second indication enables identification of the first device on its own. The first indication lacks the capability to enable identification of the first device on its own. The first node initiates determining the second indication based on the received first indication. The initiating determining is further based on the additional information known to the first node.

According to a third aspect of embodiments herein, the object is achieved by a method, performed by node. The method is for enabling the identification of the first device. The node and the first device operate in the wireless communications network. The node provides at least one of the first indication and at least a part of the additional information. The additional information enables to determine the second indication based on the first indication. The second indication enables identification of the first device on its own. The first indication is different than the second indication. The first indication lacks the capability to enable identification of the first device on its own. The node by providing the at least one of the first indication and at least the part of the additional information, thereby enables the identification of the first device by the first node. This is based on the provided at least one of the first indication and at least the part of the additional information.

According to a fourth aspect of embodiments herein, the object is achieved by the first device, for enabling identification of the first device. The first device is configured to operate in the wireless communications network. The first device is configured to determine the first indication. The first indication is configured to be different than the second indication configured to enable identification of the first device on its own. The first indication is further configured to lack the capability to enable identification of the first device on its own. The determining is configured to be based on the second indication and the additional information. The first device is further configured to provide the first indication configured to be determined to the first node configured to be operating in the wireless communications network. The providing of the first indication is configured to be over a sidelink thereby initiating enabling identification of the first device by the first node based on the additional information configured to be known to the first node.

According to a fifth aspect of embodiments herein, the object is achieved by the first node, for enabling identification of the first device ions. The first node and the first device are configured to operate in the wireless communications network. The first node is further configured to receive, over the sidelink the first indication from the first device. The first indication is configured to be different than the second indication configured to enable identification of the first device on its own. The first indication is configured to lack the capability to enable identification of the first device on its own. The first node is further configured to initiate determining the second indication based on the first indication configured to be received and on the additional information configured to be known to the first node.

According to a sixth aspect of embodiments herein, the object is achieved by the node, for enabling identification of the first device. The node and the first device are configured to operate in the wireless communications network. The node is configured to provide at least one of the first indication and at least the part of the additional information. The additional information is configured to enable to determine the second indication based on the first indication. The second indication is configured to enable identification of the first device on its own. The first indication is configured to be different than the second indication. The first indication is configured to lack the capability to enable identification of the first device on its own. The node is configured to thereby enable identification of the first device by the first node, based on the at least one of the first indication and at least the part of the additional information configured to be provided.

One advantage of embodiments herein may be understood to be that embodiments herein may help to provide privacy to the identifier of the first device, e.g., its drone ID, for example, when this may be requested to be sent via PC5 broadcast or PC5 groupcast by a public authority. This may be understood to prevent the IDs to be disclosed to normal UEs in proximity that may use such IDs in a malicious way, thereby compromising their security.

### BRIEF DESCRIPTION OF THE DRAWINGS

Examples of embodiments herein are described in more detail with reference to the accompanying drawings, according to the following description.

FIG. 1 is a schematic diagram illustrating how E-UTRAN may reconfigure an Aerial UE based on flying altitude.

FIG. 2 is a schematic diagram illustrating an example of UAS to UTM connectivity.

FIG. 3 is a schematic diagram depicting a non-limiting example of Four Tiered ID Spaces.

FIG. 4 is a schematic diagram depicting an example of a wireless communications network, according to embodiments herein.

FIG. 5 is a flowchart depicting a method performed by a first device, according to embodiments herein.

FIG. 6 is a flowchart depicting a method performed by a first node, according to embodiments herein.

FIG. 7 is a flowchart depicting a method performed by a node, according to embodiments herein.

FIG. 8 is a schematic block diagram illustrating two embodiments, in panel a) and panel b), of a first device, according to embodiments herein.

FIG. 9 is a schematic block diagram illustrating two embodiments, in panel a) and panel b), of a first node, according to embodiments herein.

FIG. 10 is a schematic block diagram illustrating two embodiments, in panel a) and panel b), of a node, according to embodiments herein.

FIG. 11 is a schematic block diagram illustrating a telecommunication network connected via an intermediate network to a host computer, according to embodiments herein.

FIG. 12 is a generalized block diagram of a host computer communicating via a base station with a user equipment over a partially wireless connection, according to embodiments herein.

FIG. 13 is a flowchart depicting embodiments of a method in a communications system including a host computer, a base station and a user equipment, according to embodiments herein.

FIG. 14 is a flowchart depicting embodiments of a method in a communications system including a host computer, a base station and a user equipment, according to embodiments herein.

FIG. 15 is a flowchart depicting embodiments of a method in a communications system including a host computer, a base station and a user equipment, according to embodiments herein.

FIG. 16 is a flowchart depicting embodiments of a method in a communications system including a host computer, a base station and a user equipment, according to embodiments herein.

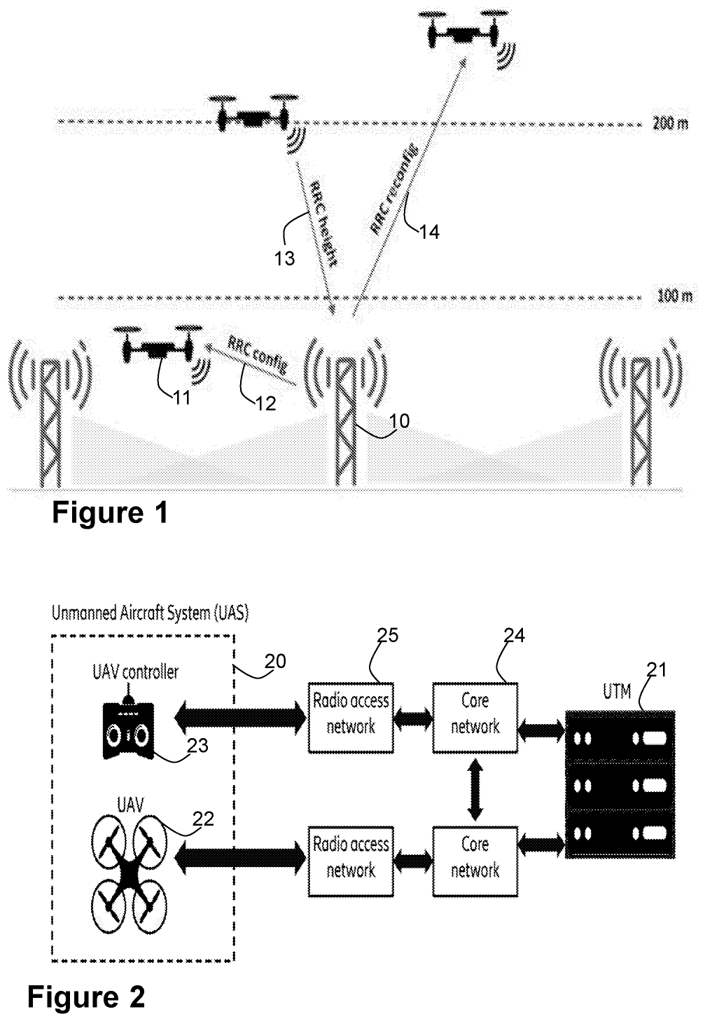

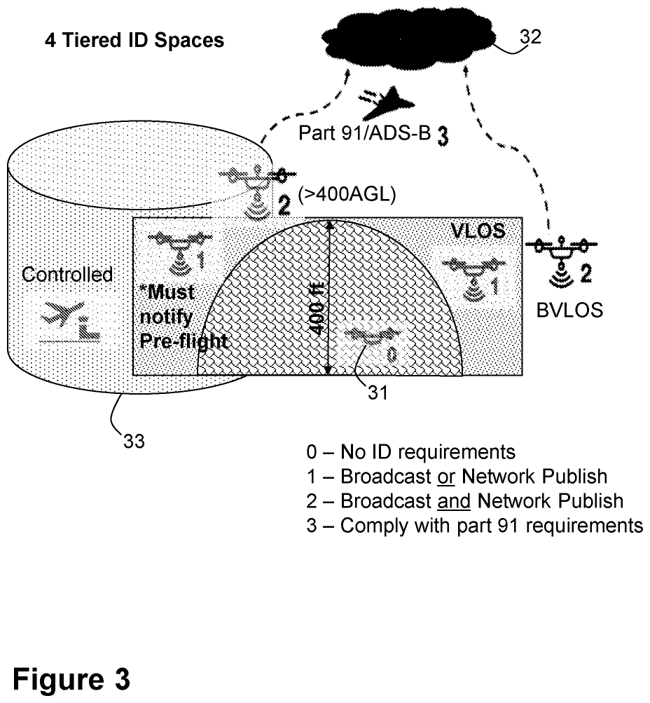

### DETAILED DESCRIPTION

The scenario considered in the examples herein may be when a public authority, may request drones in an area to identify themselves. The way how the drone may perform this may be by sending its ID via PC5 broadcast or groupcast. When doing this, other UE/drones in proximity may acquire such ID, even if the end-user of the traffic may be only the public authority.

Certain aspects of the present disclosure and their embodiments may provide solutions to the challenges discussed in the Summary or other challenges. Embodiments herein may be generally understood to relate to protecting privacy of drone IDs in broadcast transmissions.

Embodiments herein may be understood to provide methods and solutions in order to allow the privacy protection of the drone ID when this may be requested to be broadcasted over PC5 by a public authority. The solutions that may be applied in order to guarantee the privacy of the drone ID may include the following. One option may include using a salt value in order to calculate a second drone ID from the real one. The drone may send an ID, e.g., serial number or any other type of non-cellular ID, not linked to any cellular system but registered in an external network. The public authority may then need to enquiry this external network or database once that it may know this ID to achieve the real identity of the UE. The drone may broadcast a temporary ID and once that this drone may be identified by a public authority, a unicast transmission may be setup between this drone and the public authority, and eventually the “real” ID may be provided by the drone. The public authority when sending the request, either to the gNB or to the neighbour UEs in broadcast, for identifying drones in proximity, may send, along with the request, also a public key. The public key may be used by the drone to encrypt the ID and the public authority may then decrypt the message by using a public and a private key. The private key may be only used by the public authority.

The salt value, the key, or any other tool used to encrypt the UE ID may be provided by an external entity trusted by the cellular network and the public authority. When the public authority may receive all the UE ID encrypted, it may ask this external entity to decrypt them and send back the “real” ID to the public authority.

Some of the embodiments contemplated will now be described more fully hereinafter with reference to the accompanying drawings, in which examples are shown. In this section, the embodiments herein will be illustrated in more detail by a number of exemplary embodiments. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

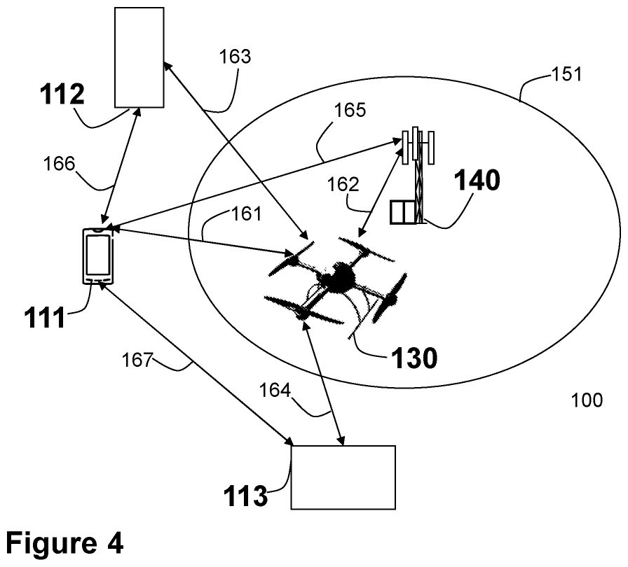

FIG. 4 depicts a non-limiting example of a wireless network or wireless communications network 100, sometimes also referred to as a wireless communications system, cellular radio system, or cellular network, in which embodiments herein may be implemented. The wireless communications network 100 may be a 5G system, 5G network, or Next Gen System or network. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE LAA, eLAA, feLAA and/or MulteFire. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. The wireless communications network 100 may be support Machine Type Communication (MTC), enhanced MTC (eMTC), Internet of Things (IoT) and/or Narrow Band IoT (NB-IoT). Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of nodes, whereof a first node 111, a second node 112 and a third node 113 are depicted in the non-limiting example of FIG. 4.

Any of the first node 111, the second node 112 and the third node 113 may be a device, such as the first device 130 described below, or a radio network node, such as the radio network node 140 described below.

The first node 111 may have a capability to request identification from a device, such as the first device 130, receive information from the first device 130, and determine its identification, e.g., within the wireless communications network 100, based on information provided by the device 130. In particular examples, the first node 111 may be a node operated by a public authority. In other examples, the first node 111 may be the radio network node 140. In examples wherein the first node 111 may be a device, it may be understood to be a second device different from the first device 130.

The second node 112 may be understood to be a node belonging to, or operated by, a party external to the wireless communications network 100. The second node 112 may have a capability to provide an identifier for the first device 130 external to and different from that provided by the wireless communications network 100.

The third node 113 may be understood to be a node operated by a trusted party.

A plurality of wireless devices may be located in the wireless communication network 100, whereof a first device 130, is depicted in the non-limiting example of FIG. 4. The first device 130 comprised in the wireless communications network 100 may be a wireless communication device such as a 5G UE, or a UE, which may also be known as e.g., mobile terminal, wireless terminal and/or mobile station, a mobile telephone, cellular telephone, or laptop with wireless capability, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a UAV, a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The first device 130 comprised in the wireless communications network 100 may be enabled to communicate wirelessly in the wireless communications network 100. The communication may be performed e.g., via a RAN, and possibly the one or more core networks, which may be comprised within the wireless communications network 100.

In particular embodiments, the first device 130 is an Unmanned Aerial Vehicle (UAV) or drone.

The wireless communications network 100 may comprise a plurality of network nodes, whereof a radio network node 140 is depicted in the non-limiting example of FIG. 4. The radio network node 140 may be a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, which are not depicted in FIG. 4, the radio network node 140 may be a distributed node, and may partially perform its functions in collaboration with a virtual node in the cloud.

The wireless communications network 100 may cover a geographical area, which in some embodiments may be divided into cell areas, wherein each cell area may be served by a radio network node, although, one radio network node may serve one or several cells. In the example of FIG. 4, the radio network node 140 serves a cell 151. The radio network node 140 may be of different classes, such as, e.g., macro eNodeB, home eNodeB or pico base station, based on transmission power and thereby also cell size. In some examples, the radio network node 140 may serve receiving nodes with serving beams. The radio network node may support one or several communication technologies, and its name may depend on the technology and terminology used. Any of the radio network nodes that may be comprised in the communications network 100 may be directly connected to one or more core networks.

The first device 130 may be configured to communicate within the wireless communications network 100 with the first node 111 over a first link 161, e.g., a radio link. The first device 130 may be configured to communicate within the wireless communications network 100 with the radio network node 140 over a second link 162, e.g., a radio link. The first device 130 may be configured to communicate with the second node 112 over a third link 163, e.g., a radio link or a wired link. The first device 130 may be configured to communicate with the third node 113 over a fourth link 164, e.g., a radio link. The first node 111 may be configured to communicate within the wireless communications network 100 with the radio network node 140 over a fifth link 165, e.g., a radio link. The first node 111 may be configured to communicate with the second node 112 over a sixth link 166, e.g., a radio link. The first node 111 may be configured to communicate with the third node 113 over a seventh link 167, e.g., a radio link.

In the non-limiting example of FIG. 4, the first node 111 is a second device. However, it may be understood that this is for illustrative purposes only, and that other combinations are also possible, as may be understood by the skilled person. It may also be understood that the wireless communications network 100 may comprise further devices and/or nodes than those represented in FIG. 4.

Any of the second node 112, the third node 113 and the radio network node 140 may be referred to as a node 112, 113, 140, which may also be referred to as fourth node 114, additional node 114, or additional node 112, 113, 140.

Embodiments herein are described within the context of LTE, that is, E-UTRAN or NR. It may be understood that the problems and solutions described herein may be equally applicable to wireless access networks and user equipments (UEs) implementing other access technologies and standards. LTE/NR may be used as an example technology where embodiments herein may be suitable, and using LTE/NR in the description therefore may be particularly useful for understanding the problem and solutions solving the problem.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, “fifth”, “sixth” and/or “seventh” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a device, such as the first device 130, e.g., a UAV; embodiments related to a first node such as the first node 111, e.g., a second device or a gNB or eNB, and embodiments related to node, such as any of the second node 112, the third node 113 or the radio network node 140, e.g., a network node, such as the radio network node 140, e.g., a gNB or an eNB.

Some embodiments herein will now be further described with some non-limiting examples.

In the following description, any reference to a/the UE, drone, or UAV may be understood to equally refer the first device 130; any reference to a/the gNB, a/the eNB and/or a/the network may be understood to equally refer to the radio network node 140; any reference to a/the public authority may be understood to equally refer to the first node 111; any reference to a/the external network may be understood to equally refer to the second node 112; and any reference to a/the trusted entity may be understood to equally refer to the third node 113.

### General

In this section, the term UE may be used to denote the aerial UEs, that is, the UAVs which may be categorized as UEs in cellular networks. Further, the term “groupcast” may be exchanged with “multicast” without any loss of meaning.

Further, in the following, the terms drone, UAVs and unmanned vehicles may be exchanged without any loss of meaning. Also, the term “device” may identify a UE device, a network node, e.g., eNB, gNB, or any other equipment capable of transmitting or receiving over the Radio Access Technology (RAT) on which the transmission and reception may be performed. It may sometimes herein be said that a drone may send something to another device, e.g., network or UE, or another drone, etc. and it may be understood that this may for example be done by a UE which may be attached/associated with the drone.

Some solutions below may be applicable to both LTE SL and NR SL, some may be applicable to NR SL only.

Also, the methods and solutions disclosed may be also applicable also to any other technology where the end-user of a traffic coming from a source may be a member within a group, if groupcast/multicast is used, or in a certain area, if broadcast is used.

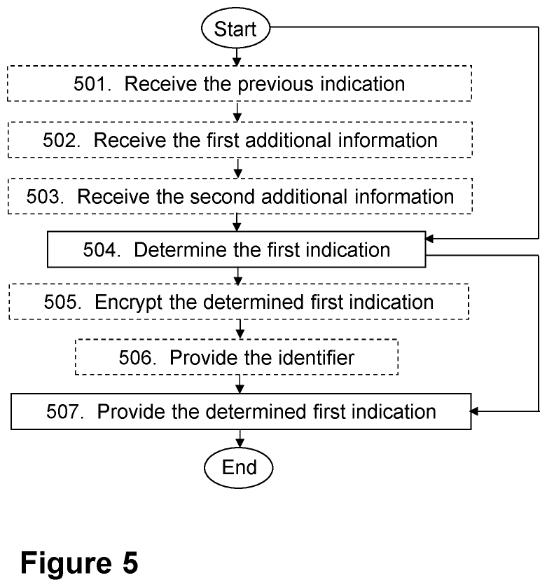

Embodiments of a method performed by a device, such as the first device 130, will now be described with reference to the flowchart depicted in FIG. 5. The method may be understood to be for handling identification of a device, such as the first device, e.g., UAV or drone. Particularly, the method may be understood to be for enabling identification of the first device. The first device 130 may be operating in a wireless communications network, such as the in the wireless communications network 100.

The wireless communications network 100 may be a 5G network or an LTE network.

In some embodiments, the wireless communications network 100 may support at least one of: New Radio (NR), Long Term Evolution (LTE), LTE for Machines (LTE-M), enhanced Machine Type Communication (eMTC), and Narrow Band Internet of Things (NB-IoT).

The method may comprise one or more of the following actions. Several embodiments are comprised herein. In some embodiments, all the actions may be performed. In some embodiments, two or more actions may be performed. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first device 130 is depicted in FIG. 5. In FIG. 5, optional actions in some embodiments may be represented with dashed lines. Some actions, e.g., Action 506, may be performed in a different order than that depicted in FIG. 5.

### Action 501

Embodiments herein may be understood to provide methods and solutions in order to allow the privacy protection of the ID of the first device 130 when this may be requested to be broadcasted over PC5 by the first node 111, e.g., a public authority. In order to guarantee the privacy of the first device 130, that is, of the drone ID, instead of the first node 130 sending its “real” ID, that is the ID of the first node 130 in the wireless communications network 100, the first node 111 may provide a first indication to the first node 111 in order to identify itself, e.g., upon a request to provide identification. The providing of the first indication may thereby initiate enabling identification of the first device 130 by the first node 111.

The first indication may be understood to lack a capability to enable identification of the first device 130 on its own, e.g., a permanent identification or identification independent of time, of the first device 130 on its own. This may be understood to be in order to prevent that entities other than the first node 111, e.g., other UE/drones in the proximity, may be able to acquire the ID of the first device 130, due to its broadcast or groupcast.

The first indication may, in agreement with the foregoing, be understood to be different than a second indication, which second indication may enable identification of the first device 130 on its own. The second indication may be, e.g., a permanent identifier assigned by the wireless communications network 100, e.g., by a core network node comprised in the wireless communications network 100, and may enable identifying the first device 130, uniquely, independent of time. That is, the second indication may be understood to not be a temporary identifier.

There may be different strategies according to embodiments herein to guarantee the privacy of the identity of the first device 130, e.g., when providing the first indication to the first node 111. In a first group of examples, or examples of group A, the strategy may comprise use of a salt value to hash the real UE information/ID of the first device 130. That is, using a salt value in order to calculate a second drone ID from the real one. In a second group of examples, or examples of group B, the strategy may comprise that the first device 130 may send information/ID via PC5 broadcast or PC5 groupcast that may be external to, or not assigned by, the 3GPP network. The first device 130 may send an ID, e.g., serial number or any other type of non-cellular ID, not linked to any cellular system but registered in an external network. The first node 111 may then need to enquiry this external network or database once that it may know this ID to achieve the real identity of the first device 130. In a third group of examples, or examples of group C, the strategy may comprise that the first device 130 may encrypt its identification/ID by using a public key. The first node 111 when sending the request, either to the radio network node 140 or to the neighbour UEs in broadcast, for identifying drones in proximity, may send, along with the request, also the public key. The public key may be used by the first device 130 to encrypt the ID and the first node 111 may then decrypt the message by using a public and a private key. The private key may be only used by the first node 111. In a fourth group of examples, or examples of group D, the strategy may comprise that the first device 130 may send a temporary information/ID via PC5 broadcast or PC5 groupcast. Once that the first device 130 may be identified by the first node 111, a unicast transmission may be setup between the first device 130 and the first node 111, and eventually the “real” ID may be provided by the public authority.

Each of these strategies will be further explained below and respectively illustrated with a number of examples.

In accordance with the foregoing, the identification of the first node 130 based on the first indication may be based on the additional information. In some embodiments, the additional information may comprise at least one of: a) a function and one of a salt value or a random value, b) a key enabling encryption and decryption of the first indication, and c) a correspondence or map between the first indication and the second indication.

In order to ultimately enable the provision of the first indication by the first device 130 and the identification of the first device 130 by the first node 111, in this Action 501, the first device 130 may receive, a previous indication. That is, another indication.

The previous indication may indicate how the first device 130 may have to provide the first indication to the first node 111. That is, the previous indication may indicate a strategy to provide privacy to the identity of the first device 130, e.g., when providing it to the first node 111. That is, whether the first device 130 may use the key, the function, the salt value, the temporary identifier, or the external identifier, e.g., provided by the second node 112, that will be described in further detail later.

According to the foregoing, that the previous indication may indicate how the first device 130 may have to provide the first indication to the first node 111 may be understood to for example comprise that the previous indication may indicate how the first device 130 may have to determine the first indication. That is, for example, using the salt value or the function, or how to send it, that is, for example, encrypted.

The previous indication may be, for example, a configuration or a reconfiguration, e.g., with a temporary identification/IDs list or pool, to perform the determining of Action 504, as will be described below.

The receiving in this Action 501 may be from the node 112, 113, 140, in which case the receiving may be performed, e.g., via the third link 163, the fourth link 164 or the second link 162.

In some examples, the receiving may be from the first node 111. In that case, receiving may be performed, e.g., via the first link 151.

### Action 502

In some embodiments, the first device 130 may not need to calculate or derive the first indication itself, but it may receive it from another node. The same may apply to the additional information that may enable a receiver to identify the first device 130 based on the first indication.

In this Action 502, the first device 130 may receive at least one of the first indication and first additional information. The first additional information may be part of the additional information. The first additional information may comprise at least one of: the function, the salt value, the random value, and the correspondence.

Examples group A: Use of a salt value to hash the real UE information/ID of the first device 130

In example #1, when the first device 130 may perform the drone remote authentication mechanism, the first device 130 may use the salt value, or the random value, as an input to the function in order to hash the information/ID that may need to be sent. The function used to hash the identification/ID may use the salt value as an input in order to perform e.g., an addition, multiplication, division, subtraction, or any other mathematical formula so that a new set of identification/ID may be derived from the original ones.

In example #2, the salt value used by the first device 130 to derive a new set of information/ID from the original one may be decided by the radio network node 140, e.g., a gNB, and sent to the first device 130 via dedicated signaling when establishing the first connection. When this salt value may be decided by the radio network node 140, the radio network node 140, in addition to sending this value to the first device 130 that may be capable to perform the drone remote authentication mechanism, it may send also this same value to the first node 111, e.g., the public authority, or the UE belonging to the public authority, that may use this salt value to derive the “real” identification/ID of the first device 130. Yet, in another example, the salt value may be decided by the public authority. When the public authority may decide the salt value, this may be sent to the radio network node 140 that may then proceed to relay this salt value to each drone that may be capable of the drone remote identification mechanism.

In example #3, a single salt value may be configured for all the drones in a certain area, or a single salt value may be configured for each drone. If the same salt value is configured for all the drones in a certain area, this may be understood to mean that each drone may use a different formula to hash the information/ID, and this formula may be assumed to be known to the first node 111, or the device of the public authority. How the first node 111 may know which formula to use for each drone, it may be because this may be informed by the radio network node 140, or because the formula may be hard-coded in the memory, or sim-card of the first device 130 by the manufacturer or mobile operator of the first device 130, and of course the manufacturer or mobile operator of the first device 130 may inform the first node 111 on which formula a given drone may use.

According to the foregoing, the one of the salt value and the random value may be configured to be one of: a) common to all devices, e.g., drones, in an area, b) device-specific, c) common to all the devices in an area, and the function, is device-specific, and d) device-specific and the function may be common to all devices, e.g., drones, in an area.

The receiving in this Action 502 may be from one of: the first node 111, the radio network node 140 serving the first device 130, the second node 112 belonging to a party external to the wireless communications network 100, and the third node 113 operating in the wireless communications network 100. Accordingly, the receiving in this Action 502 may be performed, respectively, e.g., via the first link 161, the second link 162, the third link 163 and/or the fourth link 164.

Examples group B: The first device 130 may send information/ID via PC5 broadcast or PC5 groupcast that may be external to, or not assigned by, the 3GPP network.

In some embodiments, the first indication may be: a) not linked to any cellular system and b) registered with the party external to the wireless communications network 100.

In example #4, when the first device 130 may perform the drone remote authentication mechanism, the first device 130 may send over PC5 broadcast or PC5 groupcast some information/ID that may be external to, or not assigned by, the 3GPP network. This may be understood to basically mean that such identification/ID may have been assigned by an external network such as the UTM network, e.g., by the second node 112. When receiving such drone identification/ID, the first node 111 may be able to derive the correct 3GPP information/ID via a mapping between the information/ID assigned by the 3GPP network and the ones assigned by the external network, that is, by the second node 112.

In example #5, the mapping between the identification/ID assigned by the 3GPP network and the ones assigned by the external network, e.g., via the second node 112, may be built at the radio network node 140 and then, this may be communicated to the first node 111. This may be understood to mean that each drone may be required to report to the radio network node 140 its own information/ID assigned by the external network, e.g., via the second node 112, and any other 3GPP identification/ID that may have not been assigned by the radio network node 140 itself, e.g., some ID that the first device 130 may decide itself.

Alternatively, the mapping between the identification/ID assigned by the 3GPP network and the ones assigned by the external network, e.g., via the second node 112, may be built by the external network, e.g., via the second node 112, and then communicated to the publish authority, or the first node 111 of the public authority. This may be understood to mean that each drone may be required to report to the external network, e.g., the UTM, e.g., via the second node 112, its own information/ID assigned by the 3GPP network.

In example #6, the mapping between the information/ID assigned by the 3GPP network and the ones assigned by the external network, e.g., via the second node 112, may not be known at the public authority, or the first node 111 of the public authority, but may be known only at the radio network node 140 or at the second node 112. According to this, when the first node 111 may receive the drone identification/ID, it may then inquire the 3GPP network (radio network node 140) or the second node 112 for achieving the “real” drone information/ID.

### Action 503

In this Action 503, the first device 130 may receive second additional information. The second additional information may be part of the additional information.

The second additional information may comprise a key. The key may be one of: private and public.

The key may be one of: a) common to all devices in at least an area within the wireless communications network 100, b) common to a subset of devices within the wireless communications network 100, and c) specific for the first device 130.

Examples group C: The first device 130 encrypts its identification/ID by using a public key

In example #7, when the first device 130 may perform the drone remote authentication mechanism, the first device 130 may encrypt the identification/ID by using the key. The key used to encrypt the identification/ID may be a private key, meaning that may only be known by the first node 111 and the first device 130, or the first device 130 and the radio network node 140, or the entity that may send the drone identification/ID to the first node 111, if this an information that may be relayed. Alternatively, the key used to encrypt the identification/ID may be a public key, meaning that in order to correctly decrypt the identification/ID, the first node 111 may need to have the public key, that is, the same used by the first device 130 to encrypt the identification/ID, plus a private key that may only be known by the first node 111.

In example #8, the key used by the first device 130 for encrypting the identification/ID may be sent by the first node 111 when the first message to trigger the drone remote authentication mechanism may be sent to the first device 130. Alternatively, the key used by the first device 130 for encrypting the identification/ID may be received by the radio network node 140 either via broadcast, e.g., in system information, or via dedicated signalling, e.g., in Radio Resource Control (RRC). In this case, it may be either the first node 111 to decide the key and then send this key to the radio network node 140 such that the radio network node 140 may send it to the first device 130, or it may be that the key may be decided by the radio network node 140, and then the radio network node 140 may inform the first node 111 of the key that may have been selected.

In example #9, the key used by the drone for encrypting the identification/ID may be common for all the drones, or may be valid for a group of drones, or only for a single drone. Further, the key used by the first device 130 for encrypting the identification/ID may be valid for a given timer period, and then when the key may expire, the first device 130 may need to request a new one, if this is not sent automatically. Further, if the same key is used for all the drones, or a group of drones, each drone may be configured with a different period of time in which the key may still be valid to be used.

The receiving in this Action 503 may be from at least one of: i) the first node 111; in some of such examples, the key may be received along with the request to provide identification from the first node 111; and ii) the radio network node 140. Accordingly, the receiving in this Action 503 may be performed, e.g., via the first link 161 and/or the second link 162, respectively.

### Action 504

In this Action 504, the first device 130 determines the first indication. As stated earlier, the first indication is different than the second indication. The second indication enables identification of the first device 130 on its own. The first indication lacks a capability to enable identification of the first device 130 on its own, e.g., a permanent identification or identification independent of time, of the first device 130 on its own. The determining in this Action 504 is based on the second indication and the additional information. The additional information may comprise the first additional information and/or second additional information. In other words, the determining, e.g., deriving of the first indication may be performed using the real ID of the first device 130 and either the function, the salt value, the random value, the correspondence, and the key, to encrypt the real ID. IN some embodiments, the determining in this Action 504 may comprise obtaining the ID assigned by the second node 112.

Determining may be understood as any of calculating, deriving, obtaining, etc.

Examples group D: The first device 130 may send a temporary information/ID via PC5 broadcast or PC5 groupcast

In example #10, when the first device 130 may perform the drone remote authentication mechanism, the first device 130 may send over PC5 broadcast or PC5 groupcast a temporary identification/ID. The temporary identification/ID may be decided by the first device 130 itself or may be allocated by the radio network node 140. Alternatively, this temporary identification/ID may be allocated by a trusted entity, via the third node 113, that may operate as a coordinator in a proximity distance, e.g., the group leader in a groupcast communication. It may be noted that the temporary identification/ID may have the same format of e.g., the International Mobile Subscriber Identity (IMSI), product serial number, or any other identity that may be considered in the remote authentication procedure first device 130.

In example #11, the temporary identification/ID may be configured to be valid only for a given timer period, a given number of transmissions, or a given number of Packet Data Units (PDUs) which may be transmitted. As an alternative, the temporary identification/ID may be valid for the whole remote authentication procedure of the first device 130, and it may expire when this may finish. Yet, in another example, the temporary identification/ID may only be valid for one transmission, and a new temporary identification/ID may be used for the next transmission. In another example, the temporary identification/ID may be valid for “N” transmissions, and after “N” transmissions a new temporary identification/ID may need to be used. Further, in yet another example, the temporary identification/ID may be only applied until a permanent one may be received, the temporary identification/ID and permanent identification/ID may be represented by two separate fields to be configured.

In accordance with the foregoing, in some embodiments, the first indication may be valid for at least one of: a period of time and for a number of transmissions. In such embodiments the first indication may be considered a temporary identifier.

In example #12, the first device 130 may be configured with a list or a pool of temporary identification/IDs. The first device 130 may randomly select any of the temporary identification/IDs for a transmission. A temporary identification/IDs may be cleared after a given number of transmissions/time period/number of PDUs which may be transmitted. The temporary identification/IDs list or pool may be reconfigured to the first device 130 from time to time when it may be necessary. Alternatively, in case the first device 130 may use all the available temporary identification/IDs configured, or part of the available pool, the first device 130 may need to ask for a reconfiguration of the security parameters. This may be understood to mean that a temporary identification/IDs may be used only once and may not be reused.

In some embodiments, the determining of Action 504 may comprise at least one of: a) selecting the first indication from a plurality of first indications available to the first device 130, and b) determining that no first indication is available from the plurality and requesting a reconfiguration of security parameters comprising the first indication.

### Action 505

In this Action 505, the first device 130 may encrypt the determined first indication. The encrypting in this Action 505 may be by using the key.

### Action 506

In some embodiments, an identifier may be assigned by one of the second node 112, and the wireless communications network 100, e.g., by the first node 111, the radio network node 140 or a core network node. The identifier may be an identifier of the first device 130.

In some of such embodiments, in this Action 506, the first device 130 may provide the identifier to one of: i) the second node 112; this may be with the proviso the identifier is assigned by the wireless communications network 100, wherein the identifier may be the second indication, ii) the first node 111; this may be with the proviso the identifier is assigned by the second node 112, iii) the radio network node 140; this may be with the proviso the identifier is assigned by the second node 112, and iv) the third node 113 with the proviso the identifier is assigned by the wireless communications network 100 wherein the identifier is the second indication.

In some embodiments, the first indication may be the identifier.

### Action 507

In this Action 507, the first device 130 provides the determined first indication.

In some embodiments, the providing in this Action 507 may be by one of groupcast and broadcast.

The providing in Action 507 may be to the first node 111 operating in the wireless communications network 100.

The providing in this Action 507 may be over a sidelink, e.g., the first link 161. The sidelink may be performed via a PC5 interface.

In embodiments wherein the first device 130 may have performed Action 505, the provided first indication may be the encrypted first indication.

The providing in Action 507 may thereby initiate enabling identification of the first device 130 by the first node 111. The identification may be based on the additional information. The additional information may be known to the first node 111. The salt value, the key, or any other tool used to encrypt the ID of the first device 130, the UE ID, may be provided by an external entity trusted by the cellular network, via the second node 112, and the first node 111. When the first node 111 may receive all the UE ID encrypted, it may ask this second node 112 to decrypt them and send back the “real” ID to the first node 111.

By providing the determined first indication and not the second indication to the first node 111, the first device 130 may enable the first node 111 to identify the first device 130, while the privacy of the first device 130 may be preserved, which may avoid its capture by a malicious party.

The providing in this Action 507 may be understood as e.g., sending or transmitting, and may be performed, e.g., via the first link 161, and/or the second link 162.

The providing in Action 507 may be triggered by a received request from the first node 111.

How the first device 130 may send its own ID via PC5 broadcast or PC5 groupcast is already addressed in a previous non-published internal reference implementation.

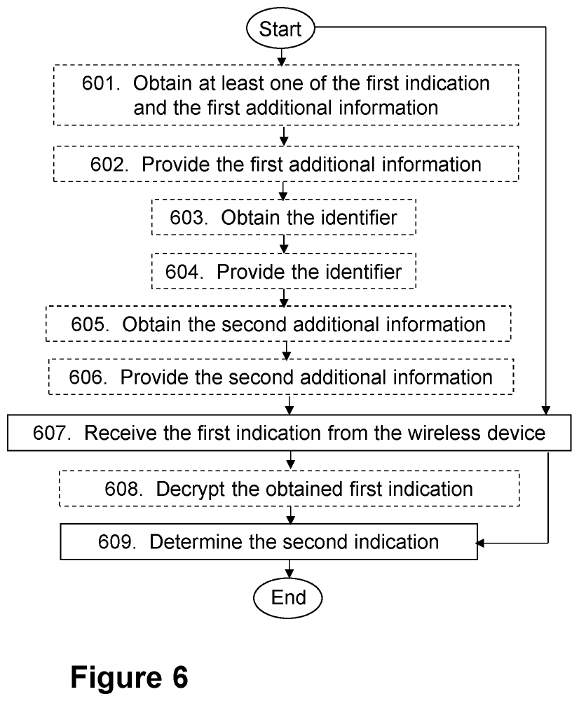

Embodiments of a method, performed by a first node, such as the first node 111, will now be described with reference to the flowchart depicted in FIG. 6. The method may be understood to be for handling identification of a device, such as the first device 130. Particularly, the method may be understood to be for enabling identification of the first device 130. The first node 111 and the first device 130 operate in a wireless communications network, such as in the wireless communications network 100.

The method may comprise two or more of the following actions. In some embodiments, all the actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the first node 111 is depicted in FIG. 6. In FIG. 6, optional actions in some embodiments may be represented with dashed lines.

The detailed description of some of the following corresponds to the same references provided above, in relation to the actions described for the first device 130 and will thus not be repeated here to simplify the description. For example, the first device 130 may be an unmanned aerial vehicle, UAV, or drone.

### Action 601

In this Action 601, the first node 111 may obtain at least one of the first indication and the first additional information.

The first additional information may comprise at least one of: the function, the salt value, the random value, and the correspondence.

In some embodiments, the one of the salt value and the random value may be configured to be one of: a) common to all devices, e.g., drones, in an area, b) device-specific, c) common to all the devices in an area, and the function, is device-specific, and d) device-specific and the function may be common to all devices, e.g., drones, in an area.

Obtaining in this Action 601 may comprise determining or receiving.

The receiving in this Action 601 may be from one of: the radio network node 140 serving the first device 130, e.g., via the fifth link 165, the second node 112 belonging to the party external to the wireless communications network 100, e.g., via the sixth link 166, and the third node 113 operating in the wireless communications network 100, e.g., via the seventh link 167.

### Action 602

In this Action 602, the first node 111 may provide the first additional information.

The providing in Action 602 may be towards the first device 130, e.g., via the radio network node 140.

The providing in Action 605 may be over a sidelink, e.g., the first link 161. The sidelink may be performed via a PC5 interface.

The providing in this Action 602 may thereby initiate enabling that the first device 130 may determine the first indication.

### Action 603

In some embodiments wherein the identifier of the first device 130 may have been assigned by one of the second node 112, and the wireless communications network 100, e.g., by the first node 111, the radio network node 140 or a core network node, the first node 111 in this Action 603, may obtain the identifier.

The obtaining in this Action 603 of the identifier may be from the second node 112, e.g., with the proviso the identifier may have been assigned by the second node 112.

### Action 604

In some embodiments wherein the identifier of the first device 130 may have been assigned by one of the second node 112, and the wireless communications network 100, e.g., by the first node 111, the radio network node 140 or a core network node, the first node 111 in this Action 604, may provide the identifier. The providing in this Action 604 may be to at least one of: i) the first device 130, e.g., with the proviso the identifier may have been assigned by the first node 111, wherein the identifier may be the second indication; and ii) the third node 113, e.g., with the proviso the identifier may have been assigned by the wireless communications network 100, wherein the identifier may be the second indication.

The providing to the first device 130 in Action 604 may be over a sidelink, e.g., the first link 161. The sidelink may be performed via a PC5 interface.

The providing to the third node 113 may be over the seventh link 167.

The providing in this Action 602 may thereby initiate enabling that the first device 130 may determine the first indication.

### Action 605

In this Action 605, the first node 111 may obtain the second additional information.

The second additional information may comprise the key. The key may be one of: private and public.

The key may be one of: a) common to all devices in at least the area within the wireless communications network 100, b) common to the subset of devices within the wireless communications network 100, and c) specific for the first device 130.

Obtaining in this Action 605 may comprise determining or receiving, e.g., via the fifth link 165.

### Action 606

In this this Action 606, the first node 111 may provide the obtained second additional information. The providing in this Action 606 may be to at least one of: i) the first device 130, wherein the key is provided along with the request to provide identification from the first node 111; and ii) the radio network node 140.

The providing to the first device 130 in Action 604 may be over a sidelink, e.g., the first link 161. The sidelink may be performed via a PC5 interface.

The providing to the radio network node 140 may be over the fifth link 165.

### Action 607

In this Action 607, the first node 111 receives, over a sidelink, the first indication.

The receiving in this Action 607 is from the first device 130.

The sidelink may be, e.g., the first link 161. The sidelink may be performed via a PC5 interface.

The first indication is different than the second indication. The second indication enables identification of the first device 130 on its own. The first indication lacks the capability to enable identification, e.g., a permanent identification or identification independent of time, of the first device 130 on its own.

The second indication may be, e.g., the permanent identifier assigned by the wireless communications network 100, e.g., by the core network node comprised in the wireless communications network 100, and may enable identifying the first node 111, uniquely, independent of time. That is, the second indication may be understood to not be a temporary identifier.

The receiving in this Action 607 may be triggered by the request sent by the first node 111.

The receiving in this Action 607 may be by one of groupcast and broadcast.

The first node 111 may, in some examples, have sent the previous indication to the first device 130.

In some embodiments, the first indication may be: a) not linked to any cellular system and b) registered with the party external to the wireless communications network 100. The first indication may be the identifier.

In some embodiments, the first indication may be valid for at least one of: the period of time and for the number of transmissions.

### Action 608

In this Action 608, the first node 111 may decrypt the obtained first indication. The encrypting in this Action 608 may be by using the key. This Action 608 may be performed in embodiments wherein the obtained first indication may be encrypted.

### Action 609

In in this Action 609, the first node 111 initiates determining the second indication, that is, initiating identifying the first device 130. In other words, deriving the “real” identity, or non-concealed ID of the first device 130.

The initiating determining in this Action 609 may be based on the received first indication. The initiating determining in this Action 609 is further based on the additional information known to the first node 111. The additional information may comprise the first additional information and/or the second additional information.

The initiating in this Action 609 may be understood as triggering, facilitating and/or enabling the determining, e.g., by another node.

Determining may be understood as any of calculating, deriving, obtaining, etc.

In some embodiments, the additional information may comprise at least one of: a) the function and the one of the salt value or the random value, b) the key enabling encryption and decryption of the first indication, and c) the correspondence or map between the first indication and the second indication.

The one of the salt value and the random value may be configured to be one of: a) common to all devices, e.g., drones, in an area, b) device-specific, c) common to all the devices in an area, and the function, may be device-specific, and d) device-specific and the function may be common to all devices, e.g., drones, in an area.

In some embodiments, the first indication may be valid for at least one of: the period of time and for the number of transmissions. In such embodiments the first indication may be considered a temporary identifier.

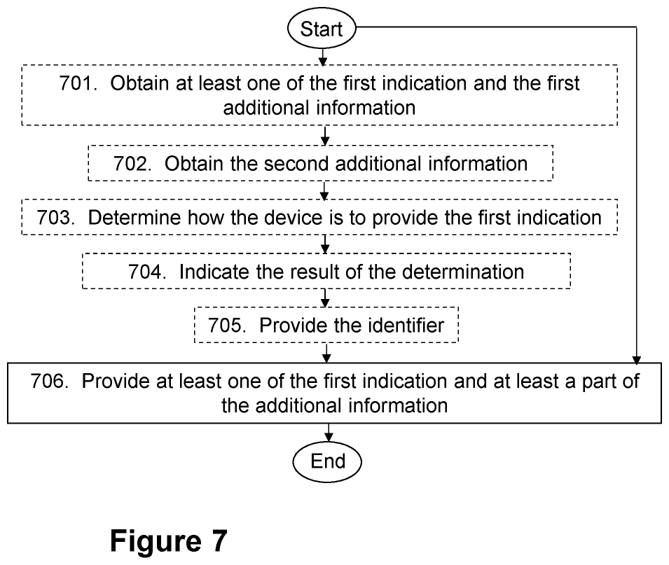

Embodiments of a method, performed by a node, such as the node 112, 113, 140, will now be described with reference to the flowchart depicted in FIG. 7. The method may be understood to be for handling identification of a device, such as the first device 130. Particularly, the method may be understood to be for enabling identification of the first device 130. The node 112, 113, 140 and the first device 130 operate in a wireless communications network, such as in the wireless communications network 100.

The method may comprise one or more of the following actions. In some embodiments, all the actions may be performed. It should be noted that the examples herein are not mutually exclusive. One or more embodiments may be combined, where applicable. Components from one embodiment may be tacitly assumed to be present in another embodiment and it will be obvious to a person skilled in the art how those components may be used in the other exemplary embodiments. All possible combinations are not described to simplify the description. A non-limiting example of the method performed by the node 112, 113, 140 is depicted in FIG. 7. In FIG. 7, optional actions in some embodiments may be represented with dashed lines.

The detailed description of some of the following corresponds to the same references provided above, in relation to the actions described for the first device 130, and/or the first node 111 and will thus not be repeated here to simplify the description. For example, the first device 130 may be an unmanned aerial vehicle, UAV, or drone.

### Action 701

In this Action 701, the node 112, 113, 140 may obtain at least one of the first indication and the first additional information.

Obtaining in this Action 701 may comprise determining or receiving.

The first additional information may comprise at least one of: the function, the salt value, the random value, and the correspondence.

The receiving in this Action 701 may be from one of: the first node 111, the radio network node 140 serving the first device 130, e.g., via the fifth link 165, the second node 112 belonging to the party external to the wireless communications network 100, e.g., via the sixth link 166, and the third node 113 operating in the wireless communications network 100, e.g., via the seventh link 167.

In some embodiments, the one of the salt value and the random value may be configured to be one of: a) common to all devices, e.g., drones, in the area, b) device-specific, c) common to all the devices in the area, and the function, is device-specific, and d) device-specific and the function may be common to all devices, e.g., drones, in the area.

### Action 702

In this Action 702, the node 112, 113, 140 may obtain the second additional information.

Obtaining in this Action 702 may comprise determining or receiving.

The second additional information may comprise the key. The key may be one of: private and public.

The obtaining in this Action 702 may be from at least one of: the first node 111 and the radio network node 140.

The key may be one of: a) common to all devices in at least an area within the wireless communications network 100, b) common to the subset of devices within the wireless communications network 100, and c) specific for the first device 130.

### Action 703

In this Action 703, the node 112, 113, 140 may determine how the first device 130 may have to provide the first indication to the first node 111, or e.g., may have to determine the first indication.

Determining may be understood as any of calculating, deriving, obtaining, etc.

In this Action 703, the node 112, 113, 140 may devise a strategy to provide privacy to the identity of the first device 130, e.g., when providing it to the first node 111. That is, whether the first device 130 may use the key, the function, the salt value, the temporary identifier, or the external identifier, e.g., provided by the second node 112.

### Action 704

In this Action 704, the node 112, 113, 140 may a result of the determination performed in Action 703.

The indicating in this Action 704 may to at least one of: the first device 130 and the first node 111.

The indicating in this Action 704 may be performed by sending the previous indication, that is, another indication, to the first device 130.

In some examples, Action 703 and Action 704 may be equally performed by the first node 111.

### Action 705

In some embodiments wherein the identifier of the first device 130 may have been assigned by one of the second node 112, and the wireless communications network 100, e.g., by the first node 111, the radio network node 140 or a core network node, the node 112, 113, 140 may, in this this Action 705, provide the identifier.

The providing in Action 704 may be to at least one of: i) the second node 112, e.g., with the proviso the identifier may have been assigned by the wireless communications network 100, wherein the identifier may be the second indication, ii) the first node 111, e.g., with the proviso the identifier may have been assigned by the second node 112, iii) the radio network node 140, e.g., with the proviso the identifier may have been assigned by the second node 112, and iv) the third node 113, e.g., with the proviso the identifier may have been assigned by the wireless communications network 100 wherein the identifier may be the second indication.

In some embodiments, the first indication may be: a) not linked to any cellular system and b) registered with the party external to the wireless communications network 100.

The providing in this Action 705 may thereby initiate enabling that the first device 130 may determine the first indication.

### Action 706

In this Action 706, the node 112, 113, 140 provides at least one of the first indication and at least a part of the additional information.

The additional information enables to determine the second indication. This enabling may be based on the first indication.

The second indication enables identification of the first device 130 on its own. The second indication may be, e.g., the permanent identifier assigned by the wireless communications network 100, e.g., by the core network node comprised in the wireless communications network 100, and may enable identifying the node 112, 113, 140, uniquely, independent of time. That is, the second indication may be understood to not be a temporary identifier.

The first indication is different than the second indication.

The first indication lacks the capability to enable identification, e.g., a permanent identification or identification independent of time, of the first device 130 on its own.

The node 112, 113, 140 by providing the at least one of the first indication and at least the part of the additional information, thereby enables the identification of the first device 130, e.g., by the first node 111. This is based on the provided at least one of the first indication and at least the part of additional information.

The providing in this Action 706 may be to the first device 130 and/or to the first node 111, or to the radio network node 140.

The providing in this Action 706 may be e.g., the second link 162, the third link 163, the fourth link 164, the fifth link 165, the sixth link 166, and/or the seventh link 167.

The providing in this Action 706 may be triggered by the request sent by the first node 111.

In some embodiments, the additional information may comprise at least one of: a) the function and the one of the salt value or the random value, b) the key enabling encryption and decryption of the first indication, and c) the correspondence or map between the first indication and the second indication.

In some embodiments, the first indication may be valid for at least one of: the period of time and for the number of transmissions. In such embodiments the first indication may be considered a temporary identifier.

The providing in this Action 706 may be by one of groupcast and broadcast.

In some embodiments, at least one of the following options may apply. According to a first option, the node 110 may be the radio network node 140; in some of such embodiments, the providing 706 of the at least one of the first indication and at least the part of the additional information may be to at least one of the first device 130, and the first node 111. According to a second option, the node may be the second node 112 belonging to the party external to the wireless communications network 100; in some of such embodiments, the providing 706 of the at least one of the first indication and at least the part of the additional information may be to at least one of the first device 130 and the first node 111. According to a third option, the node may be the third node 113 operating in the wireless communications network 100; in some of such embodiments, the providing 706 of the at least one of the first indication and at least the part of the additional information may be to at least one of the first device 130 and the first node 111.

Certain embodiments disclosed herein may provide one or more of the following technical advantage(s), which may be summarized as follows. One advantage of embodiments herein may be understood to be that embodiments herein may help to provide privacy to the identifier of devices such as the first device 130, e.g., the drone IDs, when these may be requested to be sent via PC5 broadcast or PC5 groupcast by a public authority. This may be understood to prevent the IDs to be disclosed to normal UEs in proximity that may use such IDs in a malicious way.

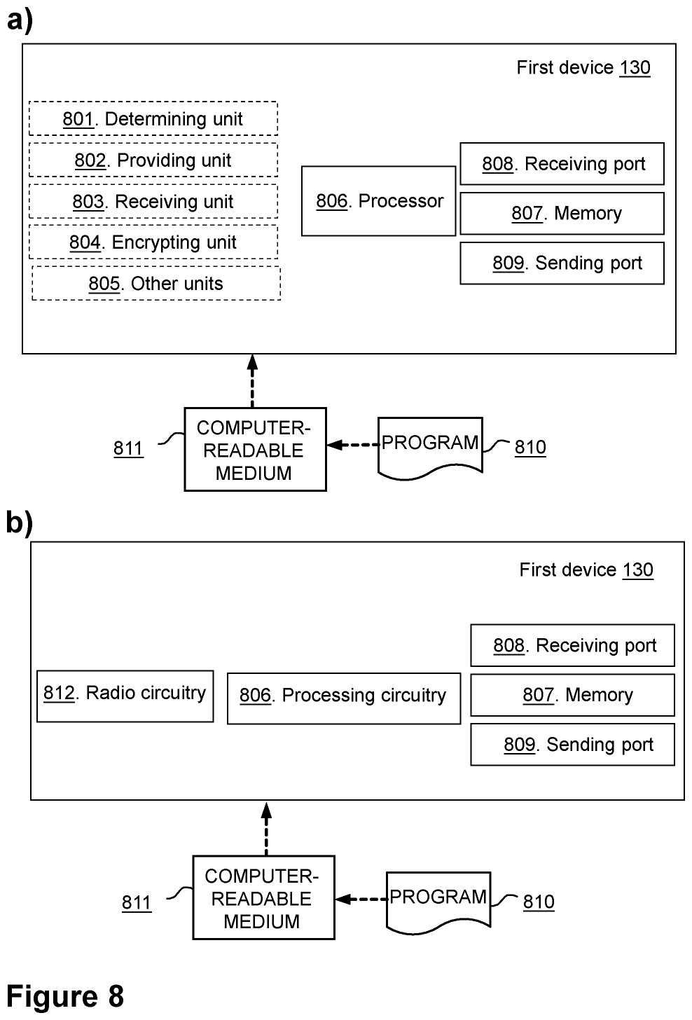

FIG. 8 depicts two different examples in panels a) and b), respectively, of the arrangement that the first device 130 may comprise to perform the method actions described above in relation to FIG. 5. In some embodiments, the first device 130 may comprise the following arrangement depicted in FIG. 8a. The first device 130 may be understood to be for enabling identification of the first device 130. The first device 130 is configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the features described for the first device 130 corresponds to that already provided when describing the method performed by the first device 130 and will therefore not be repeated here. For example, in some embodiments, the first device 130 may be configured to be an unmanned aerial vehicle, UAV.

In FIG. 8, optional units are indicated with dashed boxes.

The first device 130 is configured to perform the determining of Action 504, e.g. by means of a determining unit 801 within the first device 130, configured to determine the first indication. The first indication is configured to be different than the second indication configured to enable identification of the first device 130 on its own. The first indication is further configured to lack the capability to enable identification of the first device 130 on its own. The determining is configured to be based on the second indication and the additional information.

The first device 130 is configured to perform the providing of Action 507, e.g. by means of a providing unit 802, configured to provide the first indication configured to be determined to the first node 111 configured to be operating in the wireless communications network 100. The providing of the first indication is configured to be over a sidelink thereby initiating enabling identification of the first device 130 by the first node 111 based on the additional information configured to be known to the first node 111.

In some embodiments, the additional information may be configured to comprise at least one of: a) the function and the one of the salt value or the random value, b) the key configured to enable encryption and decryption of the first indication, and c) the correspondence or map between the first indication and the second indication.

The first device 130 may be further configured to perform the receiving of Action 502, e.g. by means of a receiving unit 803 within the first device 130, configured to receive at least one of the first indication and first additional information. The first additional information may be configured to comprise at least one of: the function, the salt value, the random value, and the correspondence, from one of: the first node 111, the radio network node 140 configured to be serving the first device 130, the second node 112 configured to belong to the party external to the wireless communications network 100, and the third node 113 configured to operate in the wireless communications network 100.

In some embodiments wherein the identifier of the first device 130 may be configured to be assigned by one of the second node 112, and the wireless communications network 100, the first device 130 may be configured to perform the providing of Action 506, e.g. by means of the providing unit 802, configured to provide the identifier to one of: i) the second node 112, with the proviso the identifier may be configured to be assigned by the wireless communications network 100, wherein the identifier may be configured to be the second indication, ii) the first node 111, with the proviso the identifier may be configured to be assigned by the second node 112, iii) the radio network node 140, with the proviso the identifier may be configured to be assigned by the second node 112, and iv) the third node 113 with the proviso the identifier may be configured to be assigned by the wireless communications network 100 wherein the identifier may be configured to be the second indication.

In some embodiments, the first indication may be configured to be: a) not linked to any cellular system and b) registered with the party external to the wireless communications network 100. In some of such embodiments, the first indication may be configured to be the identifier.

In some embodiments, the one of the salt value and the random value may be configured to be one of: a) common to all devices in an area, b) device-specific, c) common to all the devices in an area, and the function may be configured to be device-specific, and d) device-specific and the function may be configured to be common to all drones in an area.

In some embodiments, the first indication may be configured to be valid for at least one of: a period of time and for a number of transmissions.

In some embodiments, the determining may be configured to comprise at least one of: a) selecting the first indication from the plurality of first indications configured to be available to the first device 130, and b) determining that no first indication is available from the plurality and requesting the reconfiguration of security parameters configured to comprise the first indication.

The first device 130 may be further configured to perform the receiving of Action 503, e.g. by means of the receiving unit 803 within the first device 130, configured to receive the second additional information configured to comprise the key, wherein the key may be configured to be one of: private and public, from at least one of: i) the first node 111, wherein the key may be configured to be received along with the request to provide identification from the first node 111, and ii) the radio network node 140.

The first device 130 may be configured to perform the encrypting of Action 505, e.g. by means of an encrypting unit 804 within the first device 130, configured to encrypt the first indication configured to be determined by using the key. The first indication configured to be provided may be the encrypted first indication.

In some embodiments, the key may be configured to be one of: a) common to all devices in at least an area within the wireless communications network 100, b) common to the subset of devices within the wireless communications network 100, and c) specific for the first device 130.

The first device 130 may be configured to perform the receiving of Action 501, e.g. by means of the receiving unit 803 within the first device 130, configured to receive the previous indication. The previous indication may be configured to indicate how the first device 130 may have to provide the first indication to the first node 111.

In some embodiments, the providing may be configured to be by one of groupcast and broadcast.

Other units 805 may be comprised in the first device 130.

The embodiments herein in the first device 130 may be implemented through one or more processors, such as a processor 806 in the first device 130 depicted in FIG. 8a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first device 130. One such carrier may be in the form of a CD ROM disc. It is however feasible with other data carriers such as a memory stick. The computer program code may furthermore be provided as pure program code on a server and downloaded to the first device 130.

The first device 130 may further comprise a memory 807 comprising one or more memory units. The memory 807 is arranged to be used to store obtained information, store data, configurations, schedulings, and applications etc. to perform the methods herein when being executed in the first device 130.

In some embodiments, the first device 130 may receive information from, e.g., the first node 111, the second node 112, the third node 113, the radio network node 140, the node 112, 113, 140 and/or another structure in the wireless communications network 100, through a receiving port 808. In some embodiments, the receiving port 808 may be, for example, connected to one or more antennas in first device 130. In other embodiments, the first device 130 may receive information from another structure in the wireless communications network 100 through the receiving port 808. Since the receiving port 808 may be in communication with the processor 806, the receiving port 808 may then send the received information to the processor 806. The receiving port 808 may also be configured to receive other information.

The processor 806 in the first device 130 may be further configured to transmit or send information to e.g., the first node 111, the second node 112, the third node 113, the radio network node 140, the node 112, 113, 140 and/or another structure, or another structure in the wireless communications network 100, through a sending port 809, which may be in communication with the processor 806, and the memory 807.

Those skilled in the art will also appreciate that the different units 801-805 described above may refer to a combination of analog and digital modules, and/or one or more processors configured with software and/or firmware, e.g., stored in memory, that, when executed by the one or more processors such as the processor 806, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 801-805 described above may be implemented as one or more applications running on one or more processors such as the processor 806.

Thus, the methods according to the embodiments described herein for the first device 130 may be respectively implemented by means of a computer program 810 product, comprising instructions, i.e., software code portions, which, when executed on at least one processor 806, cause the at least one processor 806 to carry out the actions described herein, as performed by the first device 130. The computer program 810 product may be stored on a computer-readable storage medium 811. The computer-readable storage medium 811, having stored thereon the computer program 810, may comprise instructions which, when executed on at least one processor 806, cause the at least one processor 806 to carry out the actions described herein, as performed by the first device 130. In some embodiments, the computer-readable storage medium 811 may be a non-transitory computer-readable storage medium, such as a CD ROM disc, or a memory stick. In other embodiments, the computer program 810 product may be stored on a carrier containing the computer program 810 just described, wherein the carrier is one of an electronic signal, optical signal, radio signal, or the computer-readable storage medium 811, as described above.

The first device 130 may comprise a communication interface configured to facilitate communications between the first device 130 and other nodes or devices, e.g., the first node 111, the second node 112, the third node 113, the radio network node 140, the node 112, 113, 140 and/or another structure. The interface may, for example, include a transceiver configured to transmit and receive radio signals over an air interface in accordance with a suitable standard.

In other embodiments, the first device 130 may comprise the following arrangement depicted in FIG. 8b. The first device 130 may comprise a processing circuitry 806, e.g., one or more processors such as the processor 806, in the first device 130 and the memory 807. The first device 130 may also comprise a radio circuitry 812, which may comprise e.g., the receiving port 808 and the sending port 809. The processing circuitry 812 may be configured to, or operable to, perform the method actions according to FIG. 5, in a similar manner as that described in relation to FIG. 8a. The radio circuitry 812 may be configured to set up and maintain at least a wireless connection with the first node 111, the second node 112, the third node 113, the radio network node 140, the node 112, 113, 140 and/or another structure. Circuitry may be understood herein as a hardware component.

Hence, embodiments herein also relate to the first device 130 comprising the processing circuitry 806 and the memory 807, said memory 807 containing instructions executable by said processing circuitry 806, whereby the first device 130 is operative to perform the actions described herein in relation to the first device 130, e.g., in FIG. 5.

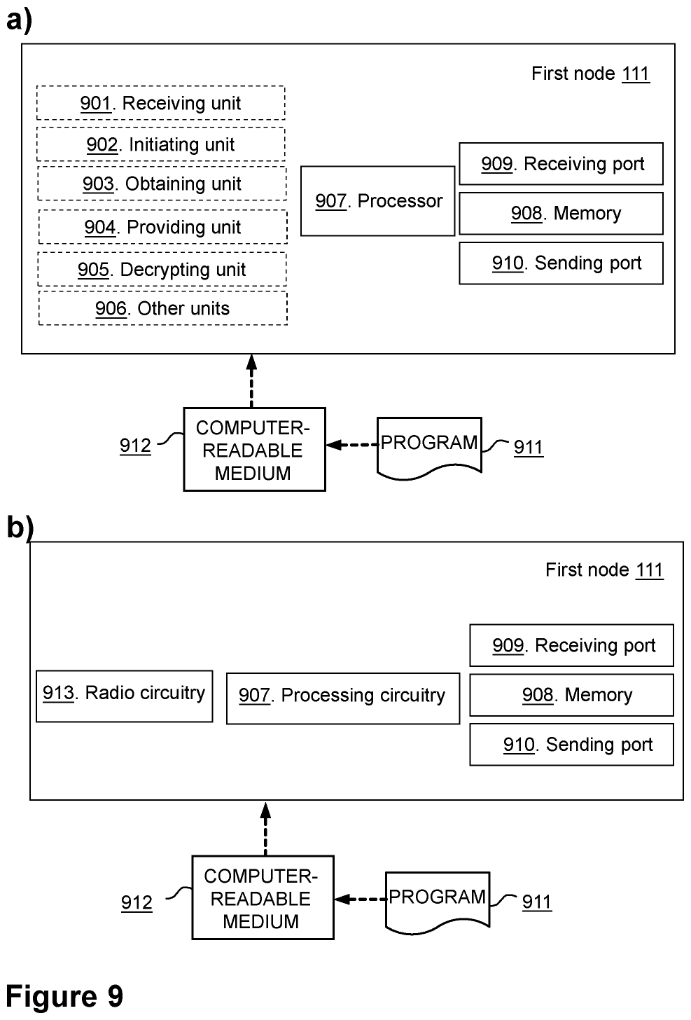

FIG. 9 depicts two different examples in panels a) and b), respectively, of the arrangement that the first node 111 may comprise to perform the method actions described above in relation to FIG. 6. In some embodiments, the first node 111 may comprise the following arrangement depicted in FIG. 9a. The first node 111 may be understood to be for enabling identification of the first device 130. The first node 111 and the first device 130 are configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the first node 111 and will thus not be repeated here. For example, in some embodiments, the first device 130 may be configured to be an unmanned aerial vehicle, UAV.

In FIG. 9, optional units are indicated with dashed boxes.

The first node 111 is configured to perform the receiving of Action 607, e.g. by means of a receiving unit 901 within the first node 111, configured to receive, over a sidelink, the first indication from the first device 130. The first indication is configured to be different than the second indication configured to enable identification of the first device 130 on its own. The first indication is configured to lack the capability to enable identification of the first device 130 on its own.

The first node 111 is configured to perform the initiating of Action 609, e.g. by means of an initiating unit 902 within the first node 111, configured to initiate determining the second indication based on the first indication configured to be received and on the additional information configured to be known to the first node 111.

In some embodiments, the additional information may be configured to comprise at least one of: a) the function and the one of the salt value or the random value, b) the key configured to enable encryption and decryption of the first indication, and c) the correspondence or map between the first indication and the second indication.

The first node 111 may be configured to perform the obtaining of Action 601, e.g. by means of an obtaining unit 903 within the first node 111, configured to obtain at least one of the first indication and first additional information. The first additional information may be configured to comprise at least one of: the function, the salt value, the random value, and the correspondence, from one of: the radio network node 140 configured to be serving the first device 130, the second node 112 configured to belong to the party external to the wireless communications network 100, and the third node 113 configured to operate in the wireless communications network 100.

The first node 111 may be configured to perform the providing of Action 602, e.g. by means of a providing unit 902, configured to provide the first additional information towards the first device 130.

In some embodiments wherein the identifier of the first device 130 may be configured to be assigned by one of the second node 112, and the wireless communications network 100, the first node 111 may be configured to perform the obtaining of Action 603, e.g. by means of the obtaining unit 903, configured to obtain the identifier from the second node 112, with the proviso the identifier is configured to be assigned by the second node 112.

In some embodiments wherein the identifier of the first device 130 may be configured to be assigned by one of the second node 112, and the wireless communications network 100, the first node 111 may be configured to perform the providing of Action 604, e.g. by means of the providing unit 902, configured to provide the identifier to at least one of: i) the first device 130, with the proviso the identifier is configured to be assigned by the first node 111; in such embodiments, the identifier may be configured to be the second indication, and ii) the third node 113 with the proviso the identifier may be configured to be assigned by the wireless communications network 100; in such embodiments, the identifier may be configured to be the second indication.

In some embodiments, the first indication may be configured to be: a) not linked to any cellular system and b) registered with the party external to the wireless communications network 100. In some of such embodiments, the first indication may be configured to be the identifier.

In some embodiments, the one of the salt value and the random value may be configured to be one of: a) common to all devices in an area, b) device-specific, c) common to all the devices in an area, and the function may be configured to be device-specific, and d) device-specific and the function may be configured to be common to all drones in an area.

In some embodiments, the first indication may be configured to be valid for at least one of: the period of time and for the number of transmissions.

The first node 111 may be configured to perform the obtaining of Action 605, e.g. by means of the obtaining unit 903 within the first node 111, configured to obtain the second additional information comprising the key, wherein the key may be one of: private and public.

The first node 111 may be configured to perform the providing of Action 606, e.g. by means of the providing unit 902, configured to provide the second additional information configured to be obtained to at least one of: i) the first device 130, wherein the key may be configured to be provided along with of Action request to provide identification from the first node 111, and ii) the radio network node 140.

The first node 111 may be configured to perform the decrypting of Action 608, e.g. by means of a decrypting unit 905 within the first node 111, configured to decrypt the first indication configured to be obtained by using the key. The first indication configured to be obtained may be configured to be encrypted.

In some embodiments, the key may be configured to be one of: a) common to all devices in at least an area within the wireless communications network 100, b) common to the subset of devices within the wireless communications network 100, and c) specific for the first device 130.

In some embodiments, the receiving may be configured to be by one of groupcast and broadcast.

Other units 906 may be comprised in the first node 111.

The embodiments herein in the first node 111 may be implemented through one or more processors, such as a processor 907 in the first node 111 depicted in FIG. 9a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the first node 111. One such carrier may be in the form of a CD ROM disc. It is however feasible with other data carriers such as a memory stick. The computer program code may furthermore be provided as pure program code on a server and downloaded to the first node 111.

The first node 111 may further comprise a memory 908 comprising one or more memory units. The memory 908 is arranged to be used to store obtained information, store data, configurations, schedulings, and applications etc. to perform the methods herein when being executed in the first node 111.

In some embodiments, the first node 111 may receive information from, e.g., the first device 130, the second node 112, the third node 113, the radio network node 140, the node 112, 113, 140 and/or another structure, through a receiving port 909. In some embodiments, the receiving port 909 may be, for example, connected to one or more antennas in first node 111. In other embodiments, the first node 111 may receive information from another structure in the wireless communications network 100 through the receiving port 909. Since the receiving port 909 may be in communication with the processor 907, the receiving port 909 may then send the received information to the processor 907. The receiving port 909 may also be configured to receive other information.

The processor 907 in the first node 111 may be further configured to transmit or send information to e.g., the first device 130, the second node 112, the third node 113, the radio network node 140, the node 112, 113, 140 and/or another structure, through a sending port 910, which may be in communication with the processor 907, and the memory 908.

Those skilled in the art will also appreciate that the different units 901-906 described above may refer to a combination of analog and digital modules, and/or one or more processors configured with software and/or firmware, e.g., stored in memory, that, when executed by the one or more processors such as the processor 907, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-906 described above may be implemented as one or more applications running on one or more processors such as the processor 907.

Thus, the methods according to the embodiments described herein for the first node 111 may be respectively implemented by means of a computer program 911 product, comprising instructions, i.e., software code portions, which, when executed on at least one processor 907, cause the at least one processor 907 to carry out the actions described herein, as performed by the first node 111. The computer program 911 product may be stored on a computer-readable storage medium 912. The computer-readable storage medium 912, having stored thereon the computer program 911, may comprise instructions which, when executed on at least one processor 907, cause the at least one processor 907 to carry out the actions described herein, as performed by the first node 111. In some embodiments, the computer-readable storage medium 912 may be a non-transitory computer-readable storage medium, such as a CD ROM disc, or a memory stick. In other embodiments, the computer program 911 product may be stored on a carrier containing the computer program 911 just described, wherein the carrier is one of an electronic signal, optical signal, radio signal, or the computer-readable storage medium 912, as described above.

The first node 111 may comprise a communication interface configured to facilitate communications between the first node 111 and other nodes or devices, e.g., the first device 130, the second node 112, the third node 113, the radio network node 140, the node 112, 113, 140 and/or another structure. The interface may, for example, include a transceiver configured to transmit and receive radio signals over an air interface in accordance with a suitable standard.

In other embodiments, the first node 111 may comprise the following arrangement depicted in FIG. 9b. The first node 111 may comprise a processing circuitry 907, e.g., one or more processors such as the processor 907, in the first node 111 and the memory 908. The first node 111 may also comprise a radio circuitry 913, which may comprise e.g., the receiving port 909 and the sending port 910. The processing circuitry 907 may be configured to, or operable to, perform the method actions according to FIG. 6, in a similar manner as that described in relation to FIG. 9a. The radio circuitry 913 may be configured to set up and maintain at least a wireless connection with the first device 130, the second node 112, the third node 113, the radio network node 140, the node 112, 113, 140 and/or another structure. Circuitry may be understood herein as a hardware component.

Hence, embodiments herein also relate to the first node 111 comprising the processing circuitry 907 and the memory 908, said memory 908 containing instructions executable by said processing circuitry 907, whereby the first node 111 is operative to perform the actions described herein in relation to the first node 111, e.g., in FIG. 6.

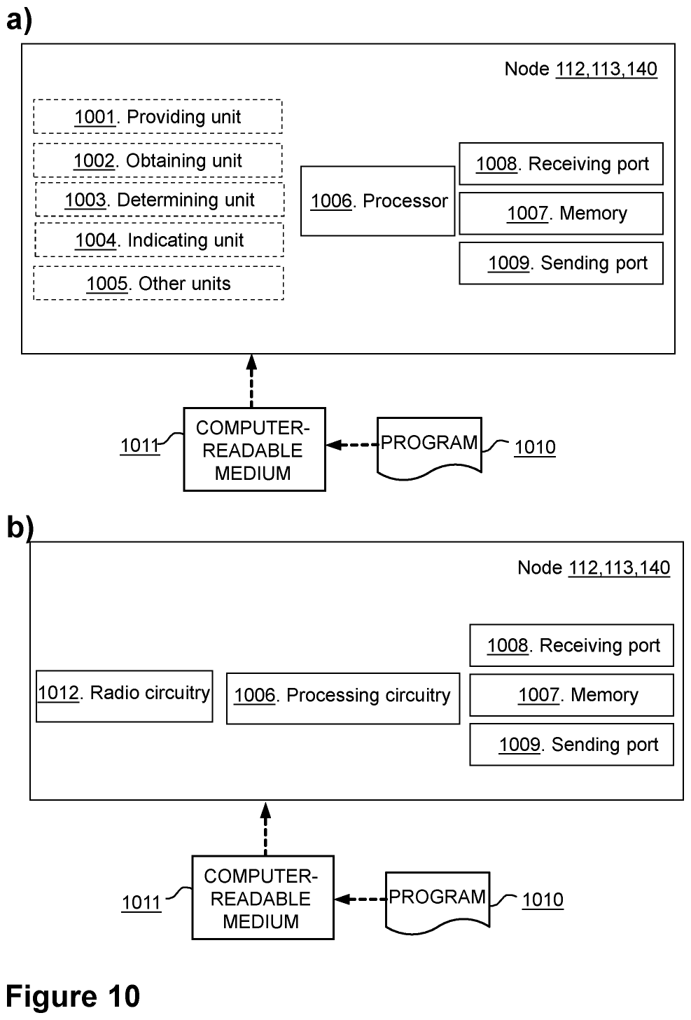

FIG. 10 depicts two different examples in panels a) and b), respectively, of the arrangement that the node 112, 113, 140 may comprise to perform the method actions described above in relation to FIG. 7. In some embodiments, the node 112, 113, 140 may comprise the following arrangement depicted in FIG. 10a. The node 112, 113, 140 may be understood to be for enabling identification of the first device 130. The node 112, 113, 140 and the first device 130 are configured to operate in the wireless communications network 100.

Several embodiments are comprised herein. It should be noted that the examples herein are not mutually exclusive. One or more embodiments may be combined, where applicable. All possible combinations are not described to simplify the description. Components from one embodiment may be tacitly assumed to be present in another embodiment and it will be obvious to a person skilled in the art how those components may be used in the other exemplary embodiments. The detailed description of some of the following corresponds to the same references provided above, in relation to the actions described for the node 112, 113, 140 and will thus not be repeated here. For example, in some embodiments, the first device 130 may be configured to be an unmanned aerial vehicle, UAV.

In FIG. 10, optional modules are indicated with dashed boxes.

The node 112, 113, 140 may be configured to perform the providing of Action 706, e.g. by means of a providing unit 1001 within the node 112, 113, 140, configured to provide at least one of the first indication and at least the part of the additional information. The additional information is configured to enable to determine the second indication based on the first indication. The second indication is configured to enable identification of the first device 130 on its own. The first indication is configured to be different than the second indication. The first indication is configured to lack the capability to enable identification of the first device 130 on its own. The node 112, 113, 140 is configured to thereby enable identification of the first device 130 by the first node 111, based on the at least one of the first indication and at least the part of the additional information configured to be provided.

In some embodiments, the additional information may be configured to comprise at least one of: a) the function and the one of the salt value or the random value, b) the key configured to enable encryption and decryption of the first indication, and c) the correspondence or map between the first indication and the second indication.

The node 112, 113, 140 may be configured to perform the obtaining of Action 701, e.g. by means of an obtaining unit 1002 within the node 112, 113, 140, configured to obtain at least one of the first indication and first additional information. The first additional information may be configured to comprise at least one of: the function, the salt value, the random value, and the correspondence, from one of: the first node 111, the radio network node 140 configured to be serving the first device 130, the second node 112 configured to belong to the party external to the wireless communications network 100, and the third node 113 configured to operate in the wireless communications network 100.

In some embodiments wherein the identifier of the first device 130 may be configured to be assigned by one of the second node 112, and the wireless communications network 100, the node 112, 113, 140 may be configured to perform the providing of Action 705, e.g. by means of the providing unit 1001, configured to provide the identifier to at least one of: i) the second node 112, with the proviso the identifier may be configured to be assigned by the wireless communications network 100; in some of such embodiments, the identifier may be configured to be the second indication, ii) the first node 111, with the proviso the identifier may be configured to be assigned by the second node 112, iii) the radio network node 140, with the proviso the identifier may be configured to be assigned by the second node 112, and iv) the third node 113 with the proviso the identifier may be configured to be assigned by the wireless communications network 100; in some of such embodiments, the identifier may be configured to be the second indication.

In some embodiments, the first indication may be configured to be: a) not linked to any cellular system and b) registered with the party external to the wireless communications network 100. In some of such embodiments, the first indication may be configured to be the identifier.

In some embodiments, the one of the salt value and the random value may be configured to be one of: a) common to all devices in an area, b) device-specific, c) common to all the devices in an area, and the function may be configured to be device-specific, and d) device-specific and the function may be configured to be common to all drones in an area.

In some embodiments, the first indication may be configured to be valid for at least one of: the period of time and for the number of transmissions.

The node 112, 113, 140 may be configured to perform the obtaining of Action 702, e.g. by means of the obtaining unit 1002 within the node 112, 113, 140, configured to obtain the second additional information configured to comprise the key. The key may be configured to be one of: private and public. The obtaining may be from at least one of: i) the first node 111, and ii) the radio network node 140.

In some embodiments, the key may be configured to be one of: a) common to all devices in at least an area within the wireless communications network 100, b) common to the subset of devices within the wireless communications network 100, and c) specific for the first device 130.

In some embodiments, the providing may be configured to be by one of groupcast and broadcast.

The node 112, 113, 140 may be configured to perform the determining of Action 703, e.g. by means of a determining unit 1003 within the node 112, 113, 140, configured to determine how the first device 130 may have to provide the first indication to the first node 111.

The node 112, 113, 140 may be configured to perform the initiating of Action 704, e.g. by means of an indicating unit 1004 within the node 112, 113, 140, configured to indicate the result of the determination to at least one of: the first device 130 and the first node 111.

In some embodiments, one of the following options may apply. According to a first option, the node 110 may be configured to be the radio network node 140, and the providing of the at least one of the first indication and at least the part of the additional information may be configured to be to at least one of the first device 130, and the first node 111. According to a second option, the node may be configured to be the second node 112 belonging to the party external to the wireless communications network 100. The providing of the at least one of the first indication and at least the part of the additional information may be configured to be to at least one of the first device 130 and the first node 111. According to a third option, the node may be configured to be the third node 113 operating in the wireless communications network 100. The providing of the at least one of the first indication and at least the part of the additional information may be configured to be to at least one of the first device 130 and the first node 111.

Other units 1005 may be comprised in the node 112, 113, 140.

The embodiments herein in the node 112, 113, 140 may be implemented through one or more processors, such as a processor 1006 in the node 112, 113, 140 depicted in FIG. 10a, together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the node 112, 113, 140. One such carrier may be in the form of a CD ROM disc. It is however feasible with other data carriers such as a memory stick. The computer program code may furthermore be provided as pure program code on a server and downloaded to the node 112, 113, 140.

The node 112, 113, 140 may further comprise a memory 1007 comprising one or more memory units. The memory 1007 is arranged to be used to store obtained information, store data, configurations, schedulings, and applications etc. to perform the methods herein when being executed in the node 112, 113, 140.

In some embodiments, the node 112, 113, 140 may receive information from, e.g., the first device 130, the first node 111, the second node 112, the third node 113, the radio network node 140 and/or another structure, through a receiving port 1008. In some embodiments, the receiving port 1008 may be, for example, connected to one or more antennas in node 112, 113, 140. In other embodiments, the node 112, 113, 140 may receive information from another structure in the wireless communications network 100 through the receiving port 1008. Since the receiving port 1008 may be in communication with the processor 1006, the receiving port 1008 may then send the received information to the processor 1006. The receiving port 1008 may also be configured to receive other information.

The processor 1006 in the node 112, 113, 140 may be further configured to transmit or send information to e.g., the first device 130, the first node 111, the second node 112, the third node 113, the radio network node 140 and/or another structure, through a sending port 1009, which may be in communication with the processor 1006, and the memory 1007.

Those skilled in the art will also appreciate that the different units 1001-1005 described above may refer to a combination of analog and digital modules, and/or one or more processors configured with software and/or firmware, e.g., stored in memory, that, when executed by the one or more processors such as the processor 1006, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 1001-1005 described above may be implemented as one or more applications running on one or more processors such as the processor 1006.

Thus, the methods according to the embodiments described herein for the node 112, 113, 140 may be respectively implemented by means of a computer program 1010 product, comprising instructions, i.e., software code portions, which, when executed on at least one processor 1006, cause the at least one processor 1006 to carry out the actions described herein, as performed by the node 112, 113, 140. The computer program 1010 product may be stored on a computer-readable storage medium 1011. The computer-readable storage medium 1011, having stored thereon the computer program 1010, may comprise instructions which, when executed on at least one processor 1006, cause the at least one processor 1006 to carry out the actions described herein, as performed by the node 112, 113, 140. In some embodiments, the computer-readable storage medium 1011 may be a non-transitory computer-readable storage medium, such as a CD ROM disc, or a memory stick. In other embodiments, the computer program 1010 product may be stored on a carrier containing the computer program 1010 just described, wherein the carrier is one of an electronic signal, optical signal, radio signal, or the computer-readable storage medium 1011, as described above.

The node 112, 113, 140 may comprise a communication interface configured to facilitate communications between the node 112, 113, 140 and other nodes or devices, e.g., the first device 130, the first node 111, the second node 112, the third node 113, the radio network node 140 and/or another structure. The interface may, for example, include a transceiver configured to transmit and receive radio signals over an air interface in accordance with a suitable standard.

In other embodiments, the node 112, 113, 140 may comprise the following arrangement depicted in FIG. 10b. The node 112, 113, 140 may comprise a processing circuitry 1006, e.g., one or more processors such as the processor 1006, in the node 112, 113, 140 and the memory 1007. The node 112, 113, 140 may also comprise a radio circuitry 1012, which may comprise e.g., the receiving port 1008 and the sending port 1009. The processing circuitry 1006 may be configured to, or operable to, perform the method actions according to FIG. 7, in a similar manner as that described in relation to FIG. 10a. The radio circuitry 1012 may be configured to set up and maintain at least a wireless connection with the first device 130, the first node 111, the second node 112, the third node 113, the radio network node 140 and/or another structure. Circuitry may be understood herein as a hardware component.

Hence, embodiments herein also relate to the node 112, 113, 140 comprising the processing circuitry 1006 and the memory 1007, said memory 1007 containing instructions executable by said processing circuitry 1006, whereby the node 112, 113, 140 is operative to perform the actions described herein in relation to the node 112, 113, 140, e.g., in FIG. 7.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

### EXAMPLES OF, OR RELATED TO, EMBODIMENTS HEREIN

Examples related to embodiments herein may be as follows.

### Example 1

A method, performed by a first device (130), for enabling identification of the first device (130), the first device (130) operating in a wireless communications network (100), the method comprising:
determining (504) a first indication, the first indication being different than a second indication enabling identification of the first device (130) on its own, and the first indication lacking a capability to enable identification, e.g., a permanent identification or identification independent of time, of the first device (130) on its own, wherein the determining (504) is based on the second indication and additional information, and
providing (507) the determined first indication to a first node (111) operating in the wireless communications network (100) over a sidelink thereby initiating enabling identification of the first device (130) by the first node (111) based on the additional information known to the first node (111).

### Example 2

The method according to example 1, wherein the additional information comprises at least one of:
a. a function and one of a salt value or a random value,
b. a key enabling encryption and decryption of the first indication, and
c. a correspondence or map between the first indication and the second indication.

### Example 3

The method according to example 2, wherein the method further comprises:
receiving (502) at least one of the first indication and first additional information, the first additional information comprising at least one of: the function, the salt value, the random value, and the correspondence, from one of: the first node (111), a radio network node (140) serving the first device (130), a second node (112) belonging to a party external to the wireless communications network (100), and a third node (113) operating in the wireless communications network (100).

### Example 4

The method according to example 3, wherein an identifier of the first device (130) is assigned by one of the second node (112), and the wireless communications network (100), and wherein the method further comprises:
providing (506) the identifier to one of:
   i. the second node (112), with the proviso the identifier is assigned by the wireless communications network (100), wherein the identifier is the second indication,
   ii. the first node (111), with the proviso the identifier is assigned by the second node (112),
   iii. the radio network node (140), with the proviso the identifier is assigned by the second node (112), and
   iv. the third node (113) with the proviso the identifier is assigned by the wireless communications network (100) wherein the identifier is the second indication.

### Example 5

The method according to any of examples 2-4, wherein the one of the salt value and the random value are configured to be one of:
d. common to all devices in an area,
e. device-specific,
f. common to all the devices in an area, and the function, is device-specific, and
g. device-specific and the function, is common to all drones in an area.

### Example 6

The method according to any of examples 1-5, wherein the first indication is valid for at least one of: a period of time and for a number of transmissions.

### Example 7

The method according to any of examples 1-6, wherein the determining (504) comprises at least one of:
h. selecting the first indication from a plurality of first indications available to the first device (130),
i. determining that no first indication is available from the plurality and requesting a reconfiguration of security parameters comprising the first indication.

### Example 8

The method according to any of examples 1-7, further comprising at least one of:
receiving (503) second additional information comprising a key, wherein the key is one of: private and public, from at least one of:
   i. the first node (111), wherein the key is received along with a request to provide identification from the first node (111),
   ii. the radio network node (140), and
encrypting (505) the determined first indication by using the key, and wherein the provided first indication is the encrypted first indication.

### Example 9

The method according to example 8, wherein the key is one of:
j. common to all devices in at least an area within the wireless communications network (100),
k. common to a subset of devices within the wireless communications network (100), and
l. specific for the first device (130).

### Example 10

The method according to any of examples 1-9, further comprising:
receiving (501) a previous indication, e.g., from the node 112, 113, 140, the previous indication indicating how the first device 130 is to provide the first indication to the first node 111, how to or determine the first indication.

### Example 11

The method according to any of examples 1-10, wherein the providing (507) is by one of groupcast and broadcast.

### Example 12

A method, performed by a first node (111), for enabling identification of a first device (130), the first node (111) and the first device (130) operating in a wireless communications network (100), the method comprising:
receiving (607), over a sidelink, a first indication from the first device (130), the first indication being different than a second indication enabling identification of the first device (130) on its own, and the first indication lacking a capability to enable identification, e.g., a permanent identification or identification independent of time, of the first device (130) on its own, and
initiating (609) determining the second indication based on the received first indication and on additional information known to the first node (111).

### Example 13

The method according to example 12, wherein the additional information comprises at least one of:
m. a function and one of a salt value or a random value,
n. a key enabling encryption and decryption of the first indication, and
o. a correspondence or map between the first indication and the second indication.

### Example 14

The method according to example 13, wherein the method further comprises:
obtaining (601) at least one of the first indication and first additional information, the first additional information comprising at least one of: the function, the salt value, the random value, and the correspondence, from one of: a radio network node (140) serving the first device (130), a second node (112) belonging to a party external to the wireless communications network (100), and a third node (113) operating in the wireless communications network (100), and
providing (602) the first additional information towards the first device (130).

### Example 15

The method according to example 14, wherein an identifier of the first device (130) is assigned by one of the second node (112), and the wireless communications network (100), and wherein the method further comprises at least one of:
obtaining (603) the identifier from:
   i. the second node (112), with the proviso the identifier is assigned by the second node (112), and
providing (604) the identifier to at least one of:
   i. the first device (130), with the proviso the identifier is assigned by the first node (111), wherein the identifier is the second indication, and
   ii. the third node (113) with the proviso the identifier is assigned by the wireless communications network (100) wherein the identifier is the second indication.

### Example 16

The method according to any of examples 13-15, wherein the one of the salt value and the random value are configured to be one of:
p. common to all devices in an area,
q. device-specific,
r. common to all the devices in an area, and the function, is device-specific, and
s. device-specific and the function, is common to all drones in an area.

### Example 17

The method according to any of examples 12-16, wherein the first indication is valid for at least one of: a period of time and for a number of transmissions.

### Example 18

The method according to any of examples 12-17, further comprising at least one of:
obtaining (605) second additional information comprising a key, wherein the key is one of: private and public,
providing (606) the obtained second additional information to at least one of:
   i. the first device (130), wherein the key is provided along with a request to provide identification from the first node (111),
   ii. the radio network node (140), and
decrypting (608) the obtained first indication by using the key, wherein the obtained first indication is encrypted.

### Example 19

The method according to example 18, wherein the key is one of:
t. common to all devices in at least an area within the wireless communications network (100),
u. common to a subset of devices within the wireless communications network (100), and
v. specific for the first device (130).

### Example 20

The method according to any of examples 11-19, wherein the receiving (607) is by one of groupcast and broadcast.

### Example 21

A method, performed by a node (112, 113, 140), for enabling identification of a first device (130), the node (112, 113, 140) and the first device (130) operating in a wireless communications network (100), the method comprising:
providing (706) at least one of a first indication and at least a part of additional information, wherein the additional information enables to determine a second indication based on the first indication, the second indication enabling identification of the first device (130) on its own, the first indication being different than the second indication, and the first indication lacking a capability to enable identification, e.g., a permanent identification or identification independent of time, of the first device (130) on its own, and
thereby enabling identification of the first device (130) by a first node (111), based on the provided at least one of the first indication and at least the part of additional information.

### Example 22

The method according to example 21, wherein the additional information comprises at least one of:
w. a function and one of a salt value or a random value,
x. a key enabling encryption and decryption of the first indication, and
y. a correspondence or map between the first indication and the second indication.

### Example 23

The method according to example 22, wherein the method further comprises:
obtaining (701) at least one of the first indication and first additional information, the first additional information comprising at least one of: the function, the salt value, the random value, and the correspondence, from one of: the first node (111), a radio network node (140) serving the first device (130), a second node (112) belonging to a party external to the wireless communications network (100), and a third node (113) operating in the wireless communications network (100).

### Example 24

The method according to example 23, wherein an identifier of the first device (130) is assigned by one of the second node (112), and the wireless communications network (100), and wherein the method further comprises:
providing (705) the identifier to at least one of:
   i. the second node (112), with the proviso the identifier is assigned by the wireless communications network (100), wherein the identifier is the second indication,
   ii. the first node (111), with the proviso the identifier is assigned by the second node (112),
   iii. the radio network node (140), with the proviso the identifier is assigned by the second node (112), and
   iv. the third node (113) with the proviso the identifier is assigned by the wireless communications network (100) wherein the identifier is the second indication.

### Example 25

The method according to any of examples 22-24, wherein the one of the salt value and the random value are configured to be one of:
z. common to all devices in an area,
aa. device-specific,
bb. common to all the devices in an area, and the function, is device-specific, and
cc. device-specific and the function, is common to all drones in an area.

### Example 26

The method according to any of examples 21-25, wherein the first indication is valid for at least one of: a period of time and for a number of transmissions.

### Example 27

The method according to any of examples 21-26 and example 22, further comprising at least one of:
obtaining (702) second additional information comprising the key, wherein the key is one of: private and public, from at least one of:
   i. the first node (111),
   ii. the radio network node (140).

### Example 28

The method according to example 26, wherein the key is one of:
dd. common to all devices in at least an area within the wireless communications network (100),
ee. common to a subset of devices within the wireless communications network (100), and
ff. specific for the first device (130).

### Example 29

The method according to any of examples 21-28, wherein the providing (706) is by one of groupcast and broadcast.

### Example 30

The method according to any of examples 21-26 and example 22, further comprising at least one of:
determining (703) how the first device (130) is to provide the first indication to the first node (111), and
indicating (704) a result of the determination to at least one of: the first device (130) and the first node (111).

### Example 31

The method according to any of examples 21-30, wherein one of:
gg. the node (110) is the radio network node (140), and the providing (706) of the at least one of a first indication and at least a part of additional information is to at least one of the first device (130), and the first node (111),
hh. the node is a second node (112) belonging to a party external to the wireless communications network (100), and the providing (706) of the at least one of a first indication and at least a part of additional information is to at least one of the first device (130) and the first node (111), and
ii. the node is a third node (113) operating in the wireless communications network (100), and the providing (706) of the at least one of a first indication and at least a part of additional information is to at least one of the first device (130) and the first node (111).

### Example 32

The method according to any of claims 1-31, wherein the first device (130) is an unmanned aerial vehicle, UAV.

### Further Extensions And Variations

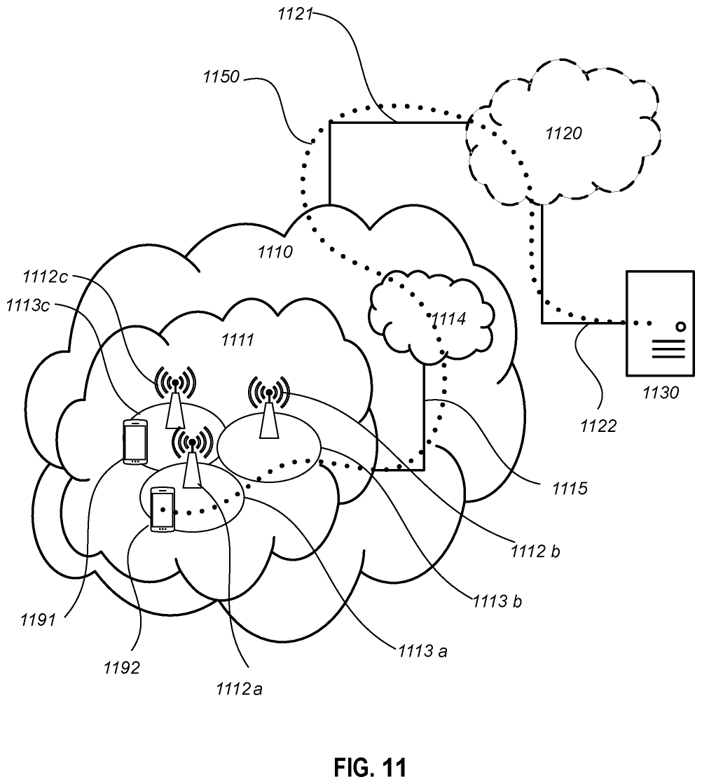

FIG. 11: Telecommunication Network Connected Via an Intermediate Network to a Host Computer in Accordance with Some Embodiments

With reference to FIG. 11, in accordance with an embodiment, a communication system includes telecommunication network 1110 such as the wireless communications network 100, for example, a 3GPP-type cellular network, which comprises access network 1111, such as a radio access network, and core network 1114. Access network 1111 comprises a plurality of network nodes such as the radio network node 140, or any of the node 112, 113, 140, the first node 111, the second node 112 and the third node 113 in examples wherein they may be network nodes. For example, base stations 1112a, 1112b, 1112c, such as NBs, eNBs, gNBs or other types of wireless access points, each defining a corresponding coverage area 1113a, 1113b, 1113c. Each base station 1112a, 1112b, 1112c is connectable to core network 1114 over a wired or wireless connection 1115. A plurality of user equipments, such as the first device 130 are comprised in the wireless communications network 100. In FIG. 11, a first UE 1191 located in coverage area 1113c is configured to wirelessly connect to, or be paged by, the corresponding base station 1112c. A second UE 1192 in coverage area 1113a is wirelessly connectable to the corresponding base station 1112a. While a plurality of UEs 1191, 1192 are illustrated in this example, the disclosed embodiments are equally applicable to a situation where a sole UE is in the coverage area or where a sole UE is connecting to the corresponding base station 1112. Any of the UEs 1191, 1192 are examples of the first device 130.

Telecommunication network 1110 is itself connected to host computer 1130, which may be embodied in the hardware and/or software of a standalone server, a cloud-implemented server, a distributed server or as processing resources in a server farm. Host computer 1130 may be under the ownership or control of a service provider, or may be operated by the service provider or on behalf of the service provider. Connections 1121 and 1122 between telecommunication network 1110 and host computer 1130 may extend directly from core network 1114 to host computer 1130 or may go via an optional intermediate network 1120. Intermediate network 1120 may be one of, or a combination of more than one of, a public, private or hosted network; intermediate network 1120, if any, may be a backbone network or the Internet; in particular, intermediate network 1120 may comprise two or more sub-networks (not shown).

The communication system of FIG. 11 as a whole enables connectivity between the connected UEs 1191, 1192 and host computer 1130. The connectivity may be described as an over-the-top (OTT) connection 1150. Host computer 1130 and the connected UEs 1191, 1192 are configured to communicate data and/or signaling via OTT connection 1150, using access network 1111, core network 1114, any intermediate network 1120 and possible further infrastructure (not shown) as intermediaries. OTT connection 1150 may be transparent in the sense that the participating communication devices through which OTT connection 1150 passes are unaware of routing of uplink and downlink communications. For example, base station 1112 may not or need not be informed about the past routing of an incoming downlink communication with data originating from host computer 1130 to be forwarded (e.g., handed over) to a connected UE 1191. Similarly, base station 1112 need not be aware of the future routing of an outgoing uplink communication originating from the UE 1191 towards the host computer 1130.

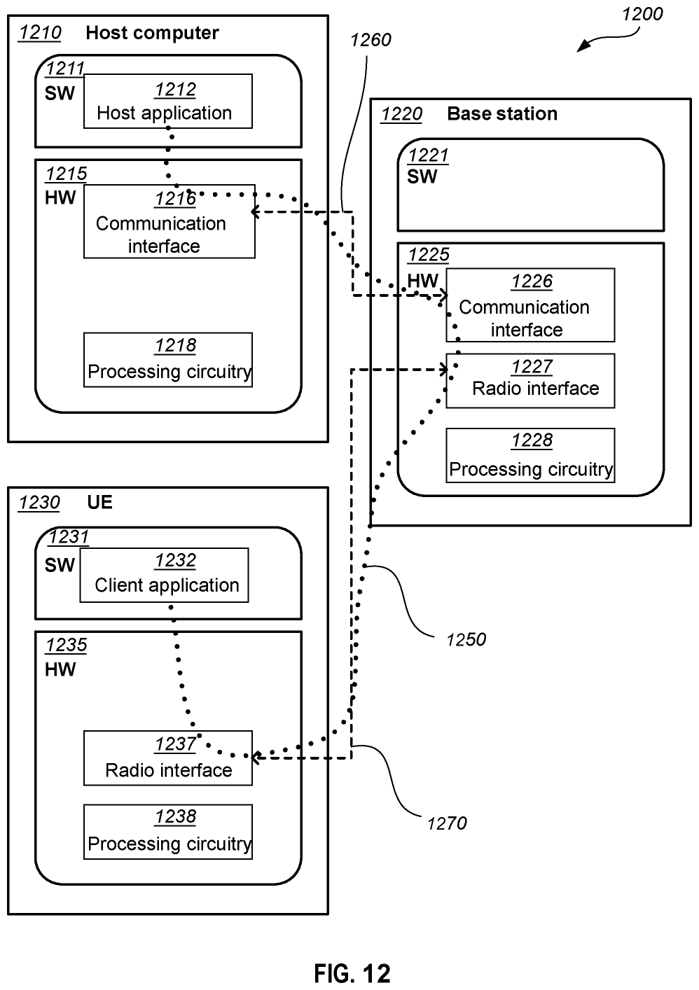

In relation to FIGS. 12, 13, 14, 15, and 16, which are described next, it may be understood that a UE is an example of the first device 130, and that any description provided for the UE equally applies to the first device 130. It may be also understood that the base station is an example of the radio network node 140, or any of the node 112, 113, 140, the first node 111, the second node 112 and the third node 113 in examples wherein they may be network nodes, and that any description provided for the base station equally applies to the radio network node 140, or any of the node 112, 113, 140, the first node 111, the second node 112 and the third node 113 in examples wherein they may be network nodes.

FIG. 12: Host Computer Communicating Via a Base Station with a User Equipment over a Partially Wireless Connection in Accordance with Some Embodiments

Example implementations, in accordance with an embodiment, of the first device 130, e.g., a UE, the radio network node 140, or any of the node 112, 113, 140, the first node 111, the second node 112 and the third node 113 in examples wherein they may be network nodes, e.g., a base station and host computer discussed in the preceding paragraphs will now be described with reference to FIG. 12. In communication system 1200, such as the wireless communications network 100, host computer 1210 comprises hardware 1215 including communication interface 1216 configured to set up and maintain a wired or wireless connection with an interface of a different communication device of communication system 1200. Host computer 1210 further comprises processing circuitry 1218, which may have storage and/or processing capabilities. In particular, processing circuitry 1218 may comprise one or more programmable processors, application-specific integrated circuits, field programmable gate arrays or combinations of these (not shown) adapted to execute instructions. Host computer 1210 further comprises software 1211, which is stored in or accessible by host computer 1210 and executable by processing circuitry 1218. Software 1211 includes host application 1212. Host application 1212 may be operable to provide a service to a remote user, such as UE 1230 connecting via OTT connection 1250 terminating at UE 1230 and host computer 1210. In providing the service to the remote user, host application 1212 may provide user data which is transmitted using OTT connection 1250.

Communication system 1200 further includes the radio network node 140, or any of the node 112, 113, 140, the first node 111, the second node 112 and the third node 113 in examples wherein they may be network nodes, exemplified in FIG. 12 as a base station 1220 provided in a telecommunication system and comprising hardware 1225 enabling it to communicate with host computer 1210 and with UE 1230. Hardware 1225 may include communication interface 1226 for setting up and maintaining a wired or wireless connection with an interface of a different communication device of communication system 1200, as well as radio interface 1227 for setting up and maintaining at least wireless connection 1270 with the first device 130, exemplified in FIG. 12 as a UE 1230 located in a coverage area (not shown in FIG. 12) served by base station 1220. Communication interface 1226 may be configured to facilitate connection 1260 to host computer 1210. Connection 1260 may be direct or it may pass through a core network (not shown in FIG. 12) of the telecommunication system and/or through one or more intermediate networks outside the telecommunication system. In the embodiment shown, hardware 1225 of base station 1220 further includes processing circuitry 1228, which may comprise one or more programmable processors, application-specific integrated circuits, field programmable gate arrays or combinations of these (not shown) adapted to execute instructions. Base station 1220 further has software 1221 stored internally or accessible via an external connection.

Communication system 1200 further includes UE 1230 already referred to. Its hardware 1235 may include radio interface 1237 configured to set up and maintain wireless connection 1270 with a base station serving a coverage area in which UE 1230 is currently located. Hardware 1235 of UE 1230 further includes processing circuitry 1238, which may comprise one or more programmable processors, application-specific integrated circuits, field programmable gate arrays or combinations of these (not shown) adapted to execute instructions. UE 1230 further comprises software 1231, which is stored in or accessible by UE 1230 and executable by processing circuitry 1238. Software 1231 includes client application 1232. Client application 1232 may be operable to provide a service to a human or non-human user via UE 1230, with the support of host computer 1210. In host computer 1210, an executing host application 1212 may communicate with the executing client application 1232 via OTT connection 1250 terminating at UE 1230 and host computer 1210. In providing the service to the user, client application 1232 may receive request data from host application 1212 and provide user data in response to the request data. OTT connection 1250 may transfer both the request data and the user data. Client application 1232 may interact with the user to generate the user data that it provides.

It is noted that host computer 1210, base station 1220 and UE 1230 illustrated in FIG. 12 may be similar or identical to host computer 1130, one of base stations 1112a, 1112b, 1112c and one of UEs 1191, 1192 of FIG. 11, respectively. This is to say, the inner workings of these entities may be as shown in FIG. 12 and independently, the surrounding network topology may be that of FIG. 11.

In FIG. 12, OTT connection 1250 has been drawn abstractly to illustrate the communication between host computer 1210 and UE 1230 via base station 1220, without explicit reference to any intermediary devices and the precise routing of messages via these devices. Network infrastructure may determine the routing, which it may be configured to hide from UE 1230 or from the service provider operating host computer 1210, or both. While OTT connection 1250 is active, the network infrastructure may further take decisions by which it dynamically changes the routing (e.g., on the basis of load balancing consideration or reconfiguration of the network).

Wireless connection 1270 between UE 1230 and base station 1220 is in accordance with the teachings of the embodiments described throughout this disclosure. One or more of the various embodiments improve the performance of OTT services provided to UE 1230 using OTT connection 1250, in which wireless connection 1270 forms the last segment. More precisely, the teachings of these embodiments may improve the latency, signalling overhead, and service interruption and thereby provide benefits such as reduced user waiting time, better responsiveness and extended battery lifetime.

A measurement procedure may be provided for the purpose of monitoring data rate, latency and other factors on which the one or more embodiments improve. There may further be an optional network functionality for reconfiguring OTT connection 1250 between host computer 1210 and UE 1230, in response to variations in the measurement results. The measurement procedure and/or the network functionality for reconfiguring OTT connection 1250 may be implemented in software 1211 and hardware 1215 of host computer 1210 or in software 1231 and hardware 1235 of UE 1230, or both. In embodiments, sensors (not shown) may be deployed in or in association with communication devices through which OTT connection 1250 passes; the sensors may participate in the measurement procedure by supplying values of the monitored quantities exemplified above, or supplying values of other physical quantities from which software 1211, 1231 may compute or estimate the monitored quantities. The reconfiguring of OTT connection 1250 may include message format, retransmission settings, preferred routing etc.; the reconfiguring need not affect base station 1220, and it may be unknown or imperceptible to base station 1220. Such procedures and functionalities may be known and practiced in the art. In certain embodiments, measurements may involve proprietary UE signaling facilitating host computer 1210's measurements of throughput, propagation times, latency and the like. The measurements may be implemented in that software 1211 and 1231 causes messages to be transmitted, in particular empty or ‘dummy’ messages, using OTT connection 1250 while it monitors propagation times, errors etc.

The first device 130 embodiments relate to FIG. 5, FIG. 8 and FIGS. 11-16.

The first device 130 may also be configured to communicate user data with a host application unit in a host computer 1210, e.g., via another link such as 1260.

The first device 130 may comprise an interface unit to facilitate communications between the first device 130 and other nodes or devices, e.g., the first node 111, the radio network node 140, the second node 112, the third node 113, the host computer 1210, and/or any other nodes or devices. In some particular examples, the interface may, for example, include a transceiver configured to transmit and receive radio signals over an air interface in accordance with a suitable standard.

The first device 130 may comprise an arrangement as shown in FIG. 8 or in FIG. 12.

The first node 111 embodiments relate to FIG. 6, FIG. 9 and FIGS. 11-16.

The first node 111 may also be configured to communicate user data with a host application unit in a host computer 1210, e.g., via another link such as 1260.

The first node 111 may comprise an interface unit to facilitate communications between the first node 111 and other nodes or devices, e.g., the first device 130, the radio network node 140, the second node 112, the third node 113, the host computer 1210, and/or any other nodes or devices. In some particular examples, the interface may, for example, include a transceiver configured to transmit and receive radio signals over an air interface in accordance with a suitable standard.

The first node 111 may comprise an arrangement as shown in FIG. 9 or in FIG. 12.

The node 112, 113, 140 embodiments relate to FIG. 7, FIG. 10 and FIGS. 11-16.

The node 112, 113, 140 may also be configured to communicate user data with a host application The node 112, 113, 140 may comprise an interface unit to facilitate communications between the node 112, 113, 140 and other nodes or devices, e.g., the first device 130, the radio network node 140, the second node 112, the third node 113, the host computer 1210, and/or any other nodes or devices. In some particular examples, the interface may, for example, include a transceiver configured to transmit and receive radio signals over an air interface in accordance with a suitable standard.

The node 112, 113, 140 may comprise an arrangement as shown in FIG. 10 or in FIG. 12.

unit in a host computer 1210, e.g., via another link such as 1270.

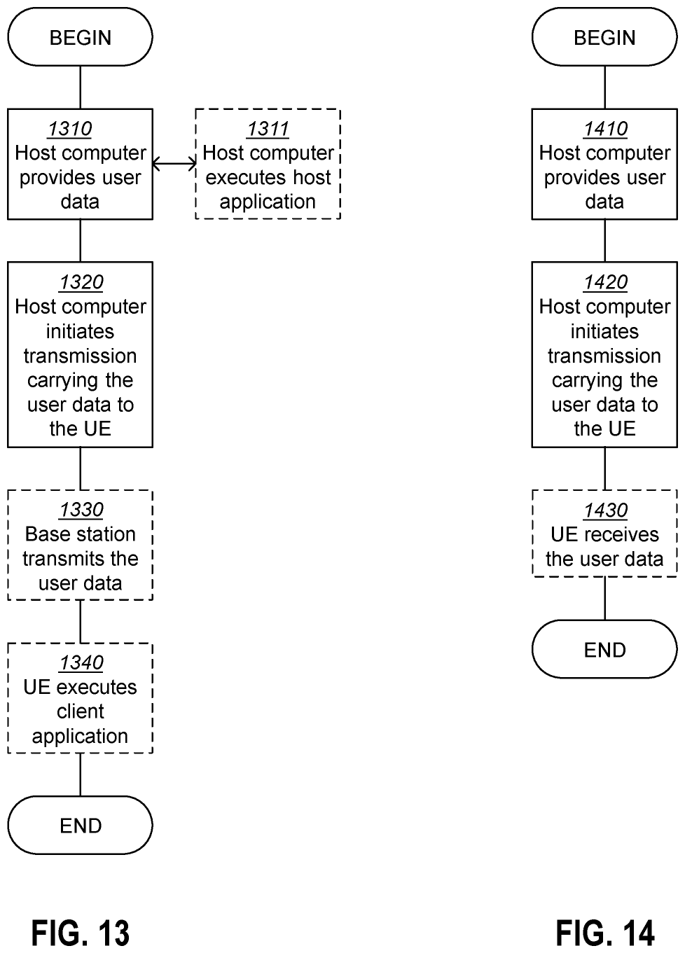

FIG. 13: Methods Implemented in a Communication System Including a Host Computer, a Base Station and a User Equipment in Accordance with Some Embodiments

FIG. 13 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 13 will be included in this section. In step 1310, the host computer provides user data. In substep 1311 (which may be optional) of step 1310, the host computer provides the user data by executing a host application. In step 1320, the host computer initiates a transmission carrying the user data to the UE. In step 1330 (which may be optional), the base station transmits to the UE the user data which was carried in the transmission that the host computer initiated, in accordance with the teachings of the embodiments described throughout this disclosure. In step 1340 (which may also be optional), the UE executes a client application associated with the host application executed by the host computer.

FIG. 14: Methods Implemented in a Communication System Including a Host Computer, a Base Station and a User Equipment in Accordance with Some Embodiments

FIG. 14 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 14 will be included in this section. In step 1410 of the method, the host computer provides user data. In an optional substep (not shown) the host computer provides the user data by executing a host application. In step 1420, the host computer initiates a transmission carrying the user data to the UE. The transmission may pass via the base station, in accordance with the teachings of the embodiments described throughout this disclosure. In step 1430 (which may be optional), the UE receives the user data carried in the transmission.

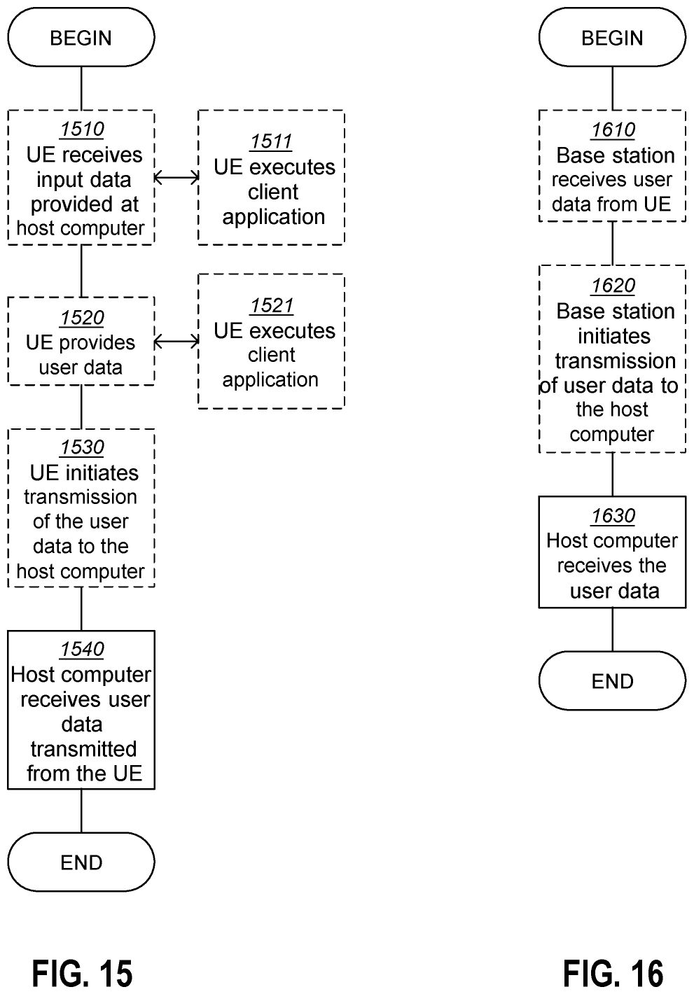

FIG. 15: Methods Implemented in a Communication System Including a Host Computer, a Base Station and a User Equipment in Accordance with Some Embodiments

FIG. 15 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 15 will be included in this section. In step 1510 (which may be optional), the UE receives input data provided by the host computer. Additionally or alternatively, in step 1520, the UE provides user data. In substep 1521 (which may be optional) of step 1520, the UE provides the user data by executing a client application. In substep 1511 (which may be optional) of step 1510, the UE executes a client application which provides the user data in reaction to the received input data provided by the host computer. In providing the user data, the executed client application may further consider user input received from the user. Regardless of the specific manner in which the user data was provided, the UE initiates, in substep 1530 (which may be optional), transmission of the user data to the host computer. In step 1540 of the method, the host computer receives the user data transmitted from the UE, in accordance with the teachings of the embodiments described throughout this disclosure.

FIG. 16: Methods Implemented in a Communication System Including a Host Computer, a Base Station and a User Equipment in Accordance with Some Embodiments

FIG. 16 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 16 will be included in this section. In step 1610 (which may be optional), in accordance with the teachings of the embodiments described throughout this disclosure, the base station receives user data from the UE. In step 1620 (which may be optional), the base station initiates transmission of the received user data to the host computer. In step 1630 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Further Numbered Embodiments

1. A base station configured to communicate with a user equipment (UE), the base station comprising a radio interface and processing circuitry configured to perform one or more of the actions described herein as performed by the radio network node 140, or any of the node 112, 113, 140, the first node 111, the second node 112 and the third node 113 in examples wherein they may be network nodes.
5. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform one or more of the actions described herein as performed by the radio network node 140, or any of the node 112, 113, 140, the first node 111, the second node 112 and the third node 113 in examples wherein they may be network nodes.
6. The communication system of embodiment 5, further including the base station.
7. The communication system of embodiment 6, further including the UE, wherein the UE is configured to communicate with the base station.
8. The communication system of embodiment 7, wherein:
   the processing circuitry of the host computer is configured to execute a host application, thereby providing the user data; and
   the UE comprises processing circuitry configured to execute a client application associated with the host application.
11. A method implemented in a base station, comprising one or more of the actions described herein as performed by the radio network node 140, or any of the node 112, 113, 140, the first node 111, the second node 112 and the third node 113 in examples wherein they may be network nodes.
15. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs one or more of the actions described herein as performed by the radio network node 140, or any of the node 112, 113, 140, the first node 111, the second node 112 and the third node 113 in examples wherein they may be network nodes.
16. The method of embodiment 15, further comprising:
   at the base station, transmitting the user data.
17. The method of embodiment 16, wherein the user data is provided at the host computer by executing a host application, the method further comprising:
   at the UE, executing a client application associated with the host application.
21. A user equipment (UE) configured to communicate with a base station, the UE comprising a radio interface and processing circuitry configured to perform one or more of the actions described herein as performed by the first device 130.
25. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's processing circuitry configured to perform one or more of the actions described herein as performed by the first device 130.
26. The communication system of embodiment 25, further including the UE.
27. The communication system of embodiment 26, wherein the cellular network further includes a base station configured to communicate with the UE.
28. The communication system of embodiment 26 or 27, wherein:
   the processing circuitry of the host computer is configured to execute a host application, thereby providing the user data; and
   the UE's processing circuitry is configured to execute a client application associated with the host application.
31. A method implemented in a user equipment (UE), comprising one or more of the actions described herein as performed by the first device 130.
35. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs one or more of the actions described herein as performed by the first device 130.
36. The method of embodiment 35, further comprising:
   at the UE, receiving the user data from the base station.
41. A user equipment (UE) configured to communicate with a base station, the UE comprising a radio interface and processing circuitry configured to perform one or more of the actions described herein as performed by the first device 130.
45. A communication system including a host computer comprising:
   a communication interface configured to receive user data originating from a transmission from a user equipment (UE) to a base station,
   wherein the UE comprises a radio interface and processing circuitry, the UE's processing circuitry configured to: perform one or more of the actions described herein as performed by the first device 130.
46. The communication system of embodiment 45, further including the UE.
47. The communication system of embodiment 46, further including the base station, wherein the base station comprises a radio interface configured to communicate with the UE and a communication interface configured to forward to the host computer the user data carried by a transmission from the UE to the base station.
48. The communication system of embodiment 46 or 47, wherein:
   the processing circuitry of the host computer is configured to execute a host application; and
   the UE's processing circuitry is configured to execute a client application associated with the host application, thereby providing the user data.
49. The communication system of embodiment 46 or 47, wherein:
   the processing circuitry of the host computer is configured to execute a host application, thereby providing request data; and
   the UE's processing circuitry is configured to execute a client application associated with the host application, thereby providing the user data in response to the request data.
51. A method implemented in a user equipment (UE), comprising one or more of the actions described herein as performed by the first device 130.
52. The method of embodiment 51, further comprising:
   providing user data; and
   forwarding the user data to a host computer via the transmission to the base station.
55. A method implemented in a communication system including a host computer, a base station and a user equipment (UE), the method comprising:
   at the host computer, receiving user data transmitted to the base station from the UE, wherein the UE performs one or more of the actions described herein as performed by the first device 130.
56. The method of embodiment 55, further comprising:
   at the UE, providing the user data to the base station.
57. The method of embodiment 56, further comprising:
   at the UE, executing a client application, thereby providing the user data to be transmitted; and
   at the host computer, executing a host application associated with the client application.
58. The method of embodiment 56, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
61. A base station configured to communicate with a user equipment (UE), the base station comprising a radio interface and processing circuitry configured to perform one or more of the actions described herein as performed by the radio network node 140, or any of the node 112, 113, 140, the first node 111, the second node 112 and the third node 113 in examples wherein they may be network nodes.
65. A communication system including a host computer comprising a communication interface configured to receive user data originating from a transmission from a user equipment (UE) to a base station, wherein the base station comprises a radio interface and processing circuitry, the base station's processing circuitry configured to perform one or more of the actions described herein as performed by the radio network node 140, or any of the node 112, 113, 140, the first node 111, the second node 112 and the third node 113 in examples wherein they may be network nodes.
66. The communication system of embodiment 65, further including the base station.
67. The communication system of embodiment 66, further including the UE, wherein the UE is configured to communicate with the base station.
68. The communication system of embodiment 67, wherein:
   the processing circuitry of the host computer is configured to execute a host application;
   the UE is configured to execute a client application associated with the host application, thereby providing the user data to be received by the host computer.
71. A method implemented in a base station, comprising one or more of the actions described herein as performed by the radio network node 140, or any of the node 112, 113, 140, the first node 111, the second node 112 and the third node 113 in examples wherein they may be network nodes.
75. A method implemented in a communication system including a host computer, a base station and a user equipment (UE), the method comprising:
   at the host computer, receiving, from the base station, user data originating from a transmission which the base station has received from the UE, wherein the UE performs one or more of the actions described herein as performed by the first device 130.
76. The method of embodiment 75, further comprising:
   at the base station, receiving the user data from the UE.
77. The method of embodiment 76, further comprising:
   at the base station, initiating a transmission of the received user data to the host computer.

### REFERENCES

1. M. Mozaffari, X. Lin, and S. Hayes, “Towards 6G with Connected Sky: UAVs and Beyond,” Online: 2103.01143.pdf (arxiv.org)

1-74. (canceled)

75. A method, performed by a first device, for enabling identification of the first device, the first device operating in a wireless communications network, the method comprising:
determining a first indication, the first indication being different than a second indication enabling identification of the first device on its own, and the first indication lacking a capability to enable identification of the first device on its own, wherein the determining is based on the second indication and additional information, and
providing the determined first indication to a first node operating in the wireless communications network over a sidelink thereby initiating enabling identification of the first device by the first node based on the additional information known to the first node.

76. The method according to claim 75, wherein the additional information comprises at least one of:
a. a function and one of a salt value or a random value,
b. a key enabling encryption and decryption of the first indication, and
c. a correspondence or map between the first indication and the second indication.

77. The method according to claim 76, wherein the method further comprises:
receiving at least one of the first indication and first additional information, the first additional information comprising at least one of: the function, the salt value, the random value, and the correspondence, from one of: the first node, a radio network node serving the first device, a second node belonging to a party external to the wireless communications network, and a third node operating in the wireless communications network.

78. The method according to claim 77, wherein an identifier of the first device is assigned by one of the second node, and the wireless communications network, and wherein the method further comprises:
providing the identifier to one of:
i. the second node, with the proviso the identifier is assigned by the wireless communications network, wherein the identifier is the second indication,
ii. the first node, with the proviso the identifier is assigned by the second node,
iii. the radio network node, with the proviso the identifier is assigned by the second node, and
iv. the third node with the proviso the identifier is assigned by the wireless communications network wherein the identifier is the second indication.

79. The method according to claim 78, wherein the first indication is: a) not linked to any cellular system and b) registered with the party external to the wireless communications network, and wherein the first indication is the identifier.

80. The method according to claim 76 wherein the one of the salt value and the random value are configured to be one of:
a. common to all devices in an area,
b. device-specific,
c. common to all the devices in an area, and the function is device-specific, and
d. device-specific and the function is common to all drones in an area.

81. The method according to claim 75, wherein the first indication is valid for at least one of: a period of time and for a number of transmissions.

82. A method, performed by a first node, for enabling identification of a first device, the first node and the first device operating in a wireless communications network, the method comprising:
receiving, over a sidelink, a first indication from the first device, the first indication being different than a second indication enabling identification of the first device on its own, and the first indication lacking a capability to enable identification of the first device on its own, and
initiating determining the second indication based on the received first indication and on additional information known to the first node.

83. The method according to claim 82, wherein the additional information comprises at least one of:
a. a function and one of a salt value or a random value,
b. a key enabling encryption and decryption of the first indication, and
c. a correspondence or map between the first indication and the second indication.

84. The method according to claim 83, wherein the method further comprises:
obtaining at least one of the first indication and first additional information, the first additional information comprising at least one of: the function, the salt value, the random value, and the correspondence, from one of: a radio network node serving the first device, a second node belonging to a party external to the wireless communications network, and a third node operating in the wireless communications network, and
providing the first additional information towards the first device.

85. The method according to claim 84, wherein an identifier of the first device is assigned by one of the second node, and the wireless communications network, and wherein the method further comprises at least one of:
obtaining the identifier from:
i. the second node, with the proviso the identifier is assigned by the second node, and
providing the identifier to at least one of:
i. the first device, with the proviso the identifier is assigned by the first node, wherein the identifier is the second indication, and
ii. the third node with the proviso the identifier is assigned by the wireless communications network wherein the identifier is the second indication.

86. The method of claim 85, wherein the first indication is: a) not linked to any cellular system and b) registered with the party external to the wireless communications network, and wherein the first indication is the identifier.

87. The method according to claim 83, wherein the one of the salt value and the random value are configured to be one of:
a. common to all devices in an area,
b. device-specific,
c. common to all the devices in an area, and the function is device-specific, and
d. device-specific and the function is common to all devices in an area.

88. A first device, for enabling identification of the first device, the first device being configured to operate in a wireless communications network, the first device being further configured to:
determine a first indication, the first indication being configured to be different than a second indication configured to enable identification of the first device on its own, and the first indication being further configured to lack a capability to enable identification of the first device on its own, wherein the determining is configured to be based on the second indication and additional information, and
provide the first indication configured to be determined to a first node configured to be operating in the wireless communications network over a sidelink thereby initiating enabling identification of the first device by the first node based on the additional information configured to be known to the first node.

89. The first device according to claim 88, wherein the additional information comprises at least one of:
a. a function and one of a salt value or a random value,
b. a key enabling encryption and decryption of the first indication, and
c. a correspondence or map between the first indication and the second indication.

90. A first node, for enabling identification of a first device, the first node and the first device being configured to operate in a wireless communications network, the first node being further configured to:
receive, over a sidelink, a first indication from the first device, the first indication being configured to be different than a second indication configured to enable identification of the first device on its own, and the first indication being configured to lack a capability to enable identification of the first device on its own, and
initiate determining the second indication based on the first indication configured to be received and on additional information configured to be known to the first node.

91. The first node according to claim 90, wherein the additional information comprises at least one of:
a. a function and one of a salt value or a random value,
b. a key enabling encryption and decryption of the first indication, and
c. a correspondence or map between the first indication and the second indication.
